(19) United States
(12) Patent Application Publication
(10) Pub. No.: US 2026/0323343 A1
(43) Pub. Date: Oct. 15, 2026

(54) SIGNALING FOR MEASUREMENT PREDICTION MODES

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Mahmoud TAHERZADEH BOROUJENI, San Diego, CA (US); Tao LUO, San Diego, CA (US)

(21) Appl. No.: 19/109,369

(22) PCT Filed: Nov. 2, 2022
(86) PCT No.: PCT/CN2022/129180

§ 371 Date: Mar. 6, 2025

(51) Int. Cl. H04W 24/10; H04W 8/22

(52) U.S. Cl. CPC H04W 24/10; H04W 8/22

(57) ABSTRACT

Various aspects of the present disclosure generally relate to wireless communication. In some aspects, a user equipment (UE) may transmit, to a network node, a capability communication indicating one or more measurement prediction modes that are supported by the UE. The UE may receive, from the network node, an indication to report predicted beam measurements using a measurement prediction mode from the one or more measurement prediction modes. The UE may transmit, to the network node, a measurement report indicating one or more predicted beam measurements, the one or more predicted beam measurements being predicted using the measurement prediction mode. Numerous other aspects are provided.

### FIELD OF THE DISCLOSURE

Aspects of the present disclosure generally relate to wireless communication, and specifically to techniques and apparatuses associated with signaling for measurement prediction modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some examples, a user equipment (UE) and/or a network node may utilize artificial intelligence (AI) and/or machine learning (ML) (AI/ML) to facilitate one or more wireless communication functions. For example, an AI/ML model may be deployed at, or on, a UE. The AI/ML model may enable the UE to determine one or more inferences or predictions based on data input to the AI/ML model. For example, the AI/ML model may be trained to output predicted beam measurements based on one or more actual beam measurements that are provided as an input to the AI/ML model. In some examples, an output of the AI/ML model may include predicted measurement values for a set of channel measurement resources (CMRs) associated with a future measurement occasion.

In some cases, the UE may operate using different measurement prediction modes. “Measurement prediction modes” may refer to operations performed by the UE associated with predicting one or more measurement values (for example, using an AI/ML model). In some cases, the different measurement prediction modes may be associated with different operations at the UE. As a result, when operating in different measurement prediction modes, the UE may have different levels of information associated with receive beams to be associated with different CMRs. However, a network node may be unaware of a measurement prediction mode in which the UE is operating. In other words, the network node may not know what additional signaling or information is to be transmitted to the UE to enable the UE to properly activate an unknown transmission configuration indicator (TCI) state because the UE may have transmitted a measurement report indicating predicted measurement values for a CMR associated with the unknown TCI state, but the UE may not have receive beam information associated with the unknown TCI state. Therefore, the network node may transmit, and the UE may receive, an indication to switch to, or activate, the unknown TCI state. However, the network node may assume (for example, incorrectly) that the UE has stored receive beam information for the unknown TCI state because the UE may have transmitted a measurement report indicating predicted measurement values for a CMR associated with the unknown TCI state. Therefore, the network node may not transmit additional signaling (for example, downlink reference signals or receive beam information) associated with the unknown TCI state. In other words, the UE may not receive information that enables the UE to identify a receive beam to be associated with the unknown TCI state. This may result in the UE being unable to receive signals using the unknown TCI state and/or may result in degraded performance associated with signals that are associated with the unknown TCI state (for example, because the UE may use a suboptimal receive beam to receive the signals.

### SUMMARY

Some aspects described herein relate to a user equipment (UE) for wireless communication. The UE may include at least one memory and at least one processor communicatively coupled with the at least one memory. The at least one processor may be operable to cause the UE to transmit, to a network node, a capability communication indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information. The at least one processor may be operable to cause the UE to receive, from the network node, an indication to report predicted beam measurements using a measurement prediction mode from the one or more measurement prediction modes. The at least one processor may be operable to cause the UE to transmit, to the network node, a measurement report indicating one or more predicted beam measurements, the one or more predicted beam measurements being predicted using the measurement prediction mode.

Some aspects described herein relate to a network node for wireless communication. The network node may include at least one memory and at least one processor communicatively coupled with the at least one memory. The at least one processor may be operable to cause the network node to receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The at least one processor may be operable to cause the network node to transmit an indication for the UE to report predicted beam measurements using a measurement prediction mode from the one or more measurement prediction modes. The at least one processor may be operable to cause the network node to receive a measurement report associated with the UE indicating one or more predicted beam measurements, the one or more predicted beam measurements being predicted using the measurement prediction mode.

Some aspects described herein relate to a method of wireless communication performed by a UE. The method may include transmitting, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The method may include receiving, from the network node, an indication to report predicted beam measurements using a measurement prediction mode from the one or more measurement prediction modes. The method may include transmitting, to the network node, a measurement report indicating one or more predicted beam measurements, the one or more predicted beam measurements being predicted using the measurement prediction mode.

Some aspects described herein relate to a method of wireless communication performed by a network node. The method may include receiving a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The method may include transmitting an indication for the UE to report predicted beam measurements using a measurement prediction mode from the one or more measurement prediction modes. The method may include receiving a measurement report associated with the UE indicating one or more predicted beam measurements, the one or more predicted beam measurements being predicted using the measurement prediction mode.

Some aspects described herein relate to a non-transitory computer-readable medium that stores a set of instructions for wireless communication by a UE. The set of instructions, when executed by one or more processors of the UE, may cause the UE to transmit, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The set of instructions, when executed by one or more processors of the UE, may cause the UE to receive, from the network node, an indication to report predicted beam measurements using a measurement prediction mode from the one or more measurement prediction modes. The set of instructions, when executed by one or more processors of the UE, may cause the UE to transmit, to the network node, a measurement report indicating one or more predicted beam measurements, the one or more predicted beam measurements being predicted using the measurement prediction mode.

Some aspects described herein relate to a non-transitory computer-readable medium that stores a set of instructions for wireless communication by a network node. The set of instructions, when executed by one or more processors of the network node, may cause the network node to receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The set of instructions, when executed by one or more processors of the network node, may cause the network node to transmit an indication for the UE to report predicted beam measurements using a measurement prediction mode from the one or more measurement prediction modes. The set of instructions, when executed by one or more processors of the network node, may cause the network node to receive a measurement report associated with the UE indicating one or more predicted beam measurements, the one or more predicted beam measurements being predicted using the measurement prediction mode.

Some aspects described herein relate to an apparatus for wireless communication. The apparatus may include means for transmitting, to a network node, a capability communication indicating one or more measurement prediction modes that are supported by the apparatus, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The apparatus may include means for receiving, from the network node, an indication to report predicted beam measurements using a measurement prediction mode from the one or more measurement prediction modes. The apparatus may include means for transmitting, to the network node, a measurement report indicating one or more predicted beam measurements, the one or more predicted beam measurements being predicted using the measurement prediction mode.

Some aspects described herein relate to an apparatus for wireless communication. The apparatus may include means for receiving a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The apparatus may include means for transmitting an indication for the UE to report predicted beam measurements using a measurement prediction mode from the one or more measurement prediction modes. The apparatus may include means for receiving a measurement report associated with the UE indicating one or more predicted beam measurements, the one or more predicted beam measurements being predicted using the measurement prediction mode.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of using beams for communications between a network node and a UE, in accordance with the present disclosure.

FIG. 5 is a diagram illustrating an example of activating a TCI state in accordance with an activation time, in accordance with the present disclosure.

FIG. 6 is a diagram illustrating an example architecture of a functional framework for radio access network (RAN) intelligence enabled by data collection in accordance with the present disclosure.

FIG. 7 is a diagram illustrating an example of artificial intelligence (AI) and/or machine learning (ML) (AI/ML) based beam management in accordance with the present disclosure.

FIG. 8 is a diagram of an example associated with signaling for measurement prediction modes in accordance with the present disclosure.

FIG. 9 is a diagram of an example associated with signaling for measurement prediction modes in accordance with the present disclosure.

FIG. 10 is a flowchart illustrating an example process performed, for example, by a UE that supports signaling for measurement prediction modes in accordance with the present disclosure.

FIG. 11 is a flowchart illustrating an example process performed, for example, by a network node that supports signaling for measurement prediction modes in accordance with the present disclosure.

FIG. 12 is a diagram of an example apparatus for wireless communication that supports signaling for measurement prediction modes in accordance with the present disclosure.

FIG. 13 is a diagram of an example apparatus for wireless communication that supports signaling for measurement prediction modes in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to signaling for measurement prediction modes. Some aspects more specifically relate to a user equipment (UE) transmitting, and a network node receiving, a capability communication indicating one or more measurement prediction modes that are supported by the UE. In some aspects, the network node may transmit, and the UE may receive, an indication to report predicted beam measurements (for example, predicted measurement values) using a measurement prediction mode from the one or more measurement prediction modes. The UE may transmit, and the network node may receive, a measurement report indicating one or more predicted beam measurements, the one or more predicted beam measurements being predicted using the measurement prediction mode.

For example, before the UE is requested to transmit predicted beam measurement values for one or more channel measurement resources (CMRs) (for example, for one or more future measurement occasions), the UE may transmit the capability communication indicating one or more measurement prediction modes that are supported by the UE. In some aspects, the capability communication may indicate a single measurement prediction mode that is used by the UE. After transmitting the capability communication, the network node may transmit, and the UE may receive, a communication requesting the UE to report one or more predicted measurement values in accordance with the indicated measurement prediction mode (for example, the single measurement prediction mode that is used by the UE). Additionally, the network node may transmit, and the UE may receive, additional signaling associated with the measurement prediction mode, such as channel state information (CSI) reference signal (CSI-RS) transmissions and/or receive beam information associated with an unknown transmission configuration indicator (TCI) state.

The one or more measurement prediction modes may include a first measurement prediction mode associated with not receiving CSI-RS transmissions for an activation of an unknown TCI state, a second measurement prediction mode associated with receiving CSI-RS transmissions for the activation of the unknown TCI state, and/or a third measurement prediction mode associated with the unknown TCI state including receive beam information, among other examples.

Particular aspects of the subject matter described in this disclosure can be implemented to realize one or more of the following potential advantages. In some examples, the described techniques can be used to enable the UE to operate in different measurement prediction modes while also ensuring that the UE receives sufficient signaling or information to select receive beams for different CMRs or TCI states. For example, by signaling a used, supported, and/or preferred measurement prediction mode of the UE, the network node may be enabled to activate an unknown TCI state (for example, that is associated with a CMR that is associated with a predicted measurement value reported by the UE) and to transmit additional signals (for example, one or more CSI-RS transmissions or receive beam information) to enable the UE to identify a best receive beam to be associated with the unknown TCI state.

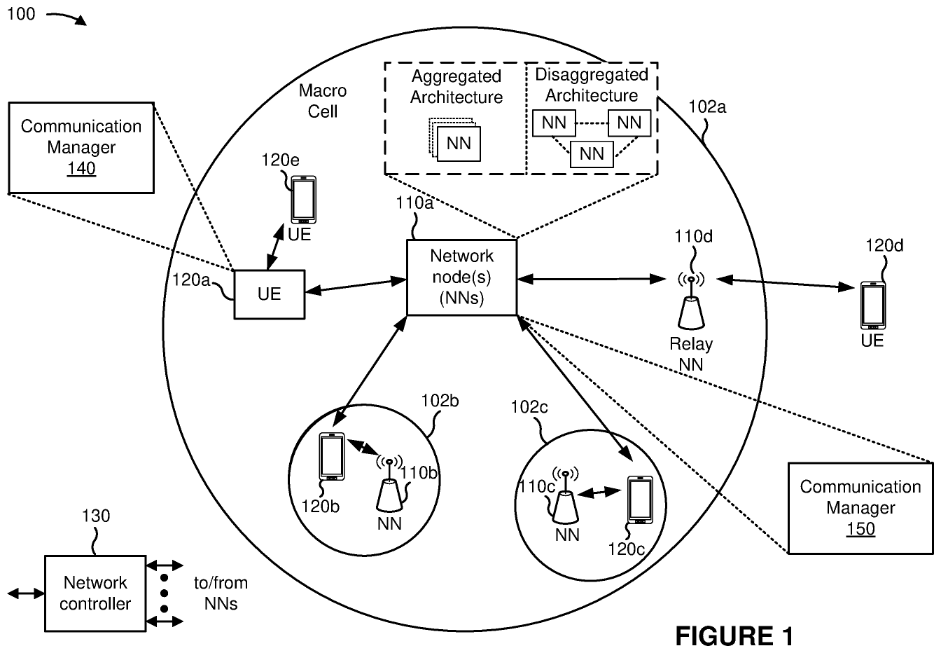

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information; receive, from the network node, an indication to report predicted beam measurements using a measurement prediction mode from the one or more measurement prediction modes; and transmit, to the network node, a measurement report indicating one or more predicted beam measurements, the one or more predicted beam measurements being predicted using the measurement prediction mode. Additionally or alternatively, the communication manager 140 may perform one or more other operations described herein.

In some aspects, the network node 110 may include a communication manager 150. As described in more detail elsewhere herein, the communication manager 150 may receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information; transmit an indication for the UE to report predicted beam measurements using a measurement prediction mode from the one or more measurement prediction modes; and receive a measurement report associated with the UE indicating one or more predicted beam measurements, the one or more predicted beam measurements being predicted using the measurement prediction mode. Additionally or alternatively, the communication manager 150 may perform one or more other operations described herein.

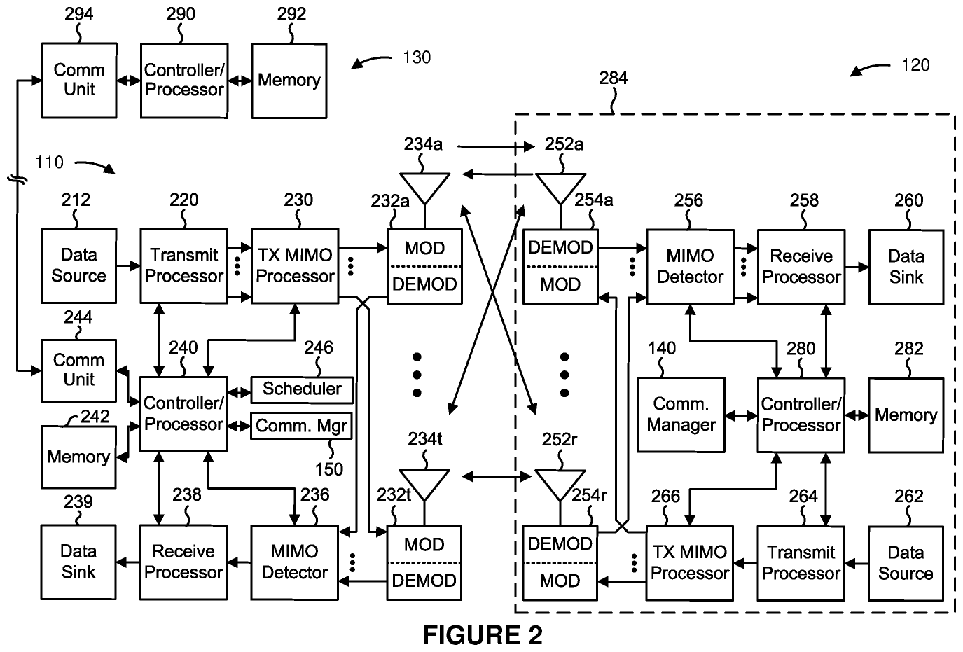

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

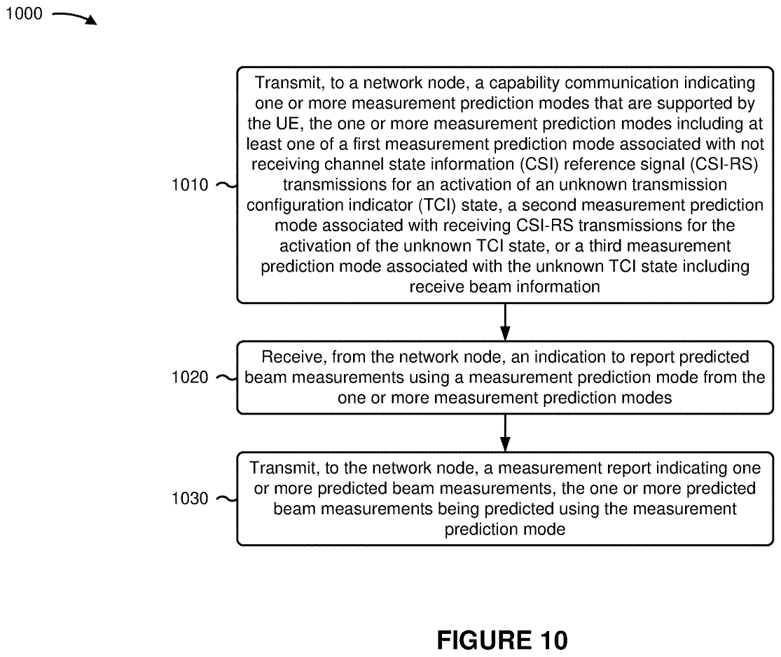

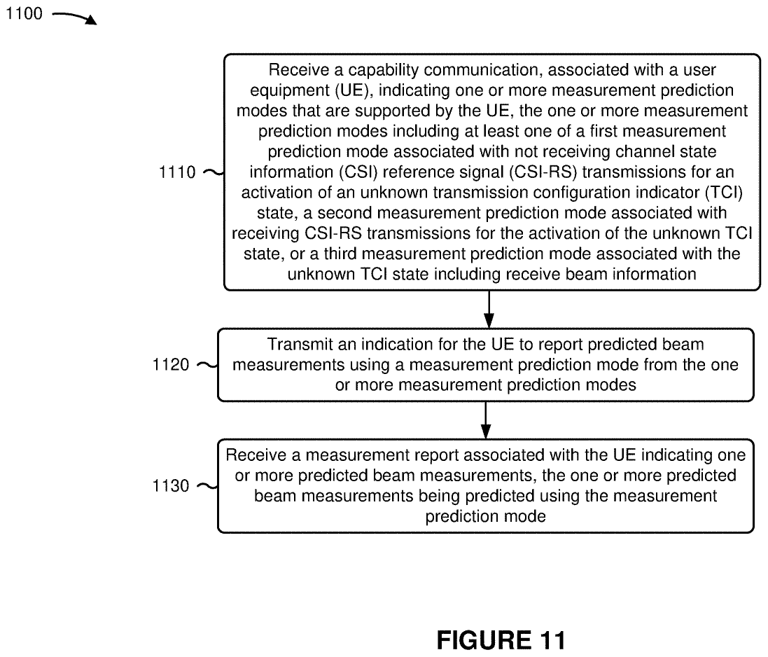

The controller/processor 240 of the network node 110, the controller/processor 280 of the UE 120, or any other component(s) of FIG. 2 may perform one or more techniques associated with signaling for measurement prediction modes, as described in more detail elsewhere herein. For example, the controller/processor 240 of the network node 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, the UE 120 includes means for transmitting, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information; means for receiving, from the network node, an indication to report predicted beam measurements using a measurement prediction mode from the one or more measurement prediction modes; and/or means for transmitting, to the network node, a measurement report indicating one or more predicted beam measurements, the one or more predicted beam measurements being predicted using the measurement prediction mode. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information; means for transmitting an indication for the UE to report predicted beam measurements using a measurement prediction mode from the one or more measurement prediction modes; and/or means for receiving a measurement report associated with the UE indicating one or more predicted beam measurements, the one or more predicted beam measurements being predicted using the measurement prediction mode. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

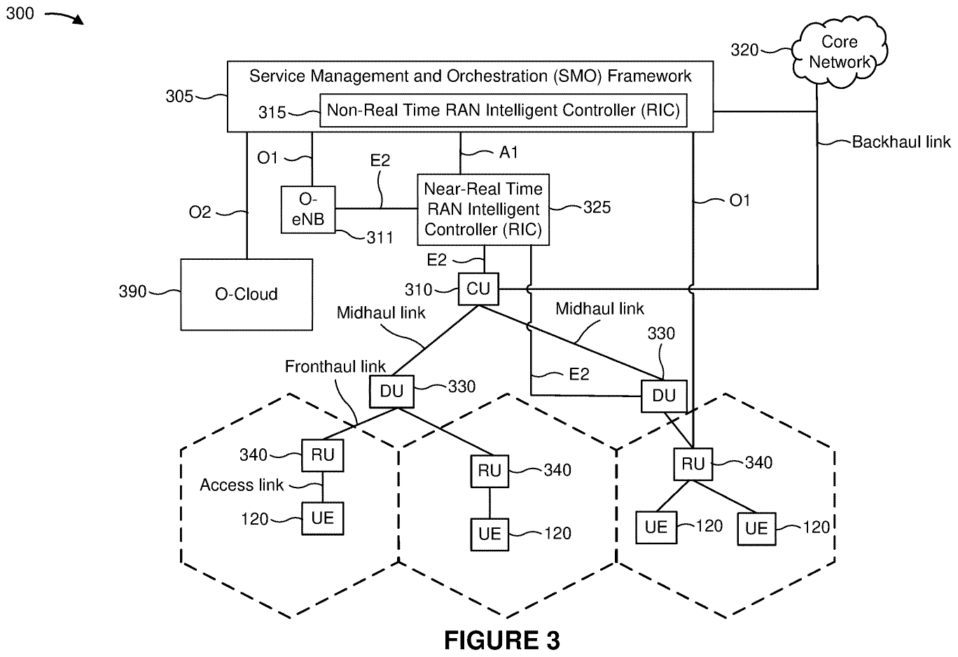

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more Dus 330 via respective midhaul links, such as through F1 interfaces. Each of the Dus 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the Cus 310, the Dus 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, Cus 310, Dus 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance.

For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

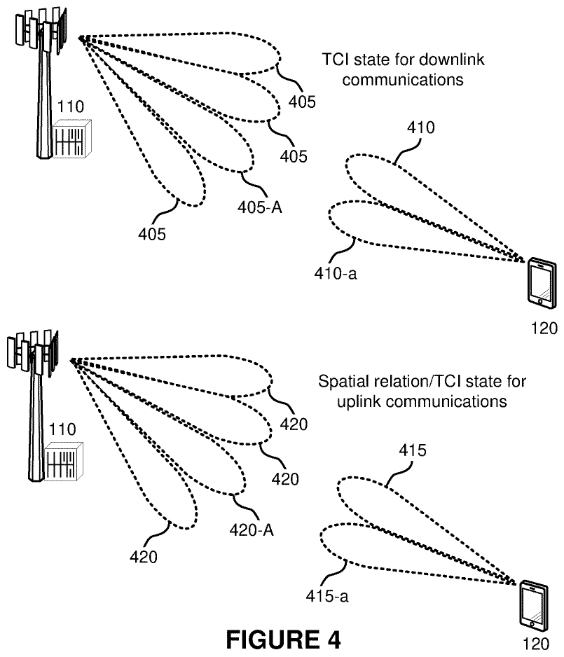

FIG. 4 is a diagram illustrating an example of using beams for communications between a network node and a UE, in accordance with the present disclosure. As shown in FIG. 4, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (network node) transmit beam (for example, a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 405.

The UE 120 may attempt to receive downlink transmissions via one or more UE receive beams 410, which may be configured using different beamforming parameters at receive circuitry of the UE 120. The UE 120 may identify a particular NN transmit beam 405, shown as NN transmit beam 405-A, and a particular UE receive beam 410, shown as UE receive beam 410-A, that provide relatively favorable performance (for example, that have a best channel quality of the different measured combinations of NN transmit beams 405 and UE receive beams 410). In some examples, the UE 120 may transmit an indication of which NN transmit beam 405 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 405-A and the UE receive beam 410-A), which may be further refined and maintained in accordance with one or more established beam refinement procedures.

A downlink beam, such as an NN transmit beam 405 or a UE receive beam 410, may be associated with a transmission configuration indication (TCI) state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each NN transmit beam 405 may be associated with a synchronization signal block (SSB), and the UE 120 may indicate a preferred NN transmit beam 405 by transmitting uplink transmissions in resources of the SSB that are associated with the preferred NN transmit beam 405. A particular SSB may have an associated TCI state (for example, for an antenna port or for beamforming). The network node 110 may, in some examples, indicate a downlink NN transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the network node 110 indicating an NN transmit beam 405 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 415.

The network node 110 may receive uplink transmissions via one or more NN receive beams 420 (for example, BS receive beams). The network node 110 may identify a particular UE transmit beam 415, shown as UE transmit beam 415-A, and a particular NN receive beam 420, shown as NN receive beam 420-A, that provide relatively favorable performance (for example, that have a best channel quality of the different measured combinations of UE transmit beams 415 and NN receive beams 420). In some examples, the network node 110 may transmit an indication of which UE transmit beam 415 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 415-A and the NN receive beam 420-A), which may be further refined and maintained in accordance with one or more established beam refinement procedures. An uplink beam, such as a UE transmit beam 415 or an NN receive beam 420, may be associated with a spatial relation. A spatial relation may indicate a directionality or a characteristic of the uplink beam, similar to one or more QCL properties, as described above.

For example, wireless communication devices, such as UEs and network nodes, may communicate with each other using beamforming. A transmitting wireless communication device may generate a transmit beam to transmit a signal, such as by applying a spatial filter to a set of antennas. A receiving wireless communication device may generate a receive beam to receive the signal, such as by applying a spatial filter to a set of antennas.

The beams used for beamformed communication may require updating such that the transmitting wireless communication device's transmit beam is aligned with the receiving wireless communication device's receive beam. A RAT such as 5G/NR may provide a mechanism for indication of which beam to use to receive a particular communication. For example, 5G/NR may provide for the signaling of information identifying a beam for a communication. In some aspects, this information may take the form of a TCI state. A TCI state (sometimes referred to as “a TCI,” where a TCI can include one or more parameters of one or more TCI states) may indicate a set of parameters (referred to as quasi co-location (QCL) parameters, where a set of QCL parameters are identified by a QCL type) and a source RS from which the set of parameters are to be derived. For example, a TCI state may indicate that an antenna port used for an RS (such as an SSB or a CSI-RS) is quasi co-located with an antenna port used for a corresponding communication. Thus, a receiving wireless communication device that receives the RS can infer the parameters for the corresponding communication. A QCL parameter may be referred to as a QCL property.

QCL types include QCL-TypeA, which includes QCL parameters of a Doppler shift, a Doppler spread, an average delay, and a delay spread; QCL-TypeB, which includes QCL parameters of a Doppler shift and a Doppler spread; QCL-TypeC, which includes QCL parameters of an average delay and a Doppler shift; and QCL-TypeD, which includes a spatial receive parameter.

TCI states may be configured, activated, and selected using a combination of RRC signaling, MAC signaling, and/or downlink control information (DCI). For example, a network node may transmit RRC signaling identifying a plurality of TCI states (in some aspects, up to 128 TCI states for a physical downlink shared channel (PDSCH) and up to 64 TCI states for a physical downlink control channel (PDCCH)). Each TCI state may identify a relevant cell and bandwidth part. After configuration, all TCI states are deactivated by default. For a PDSCH, the network node may transmit MAC signaling activating a subset of the configured TCI states. A TCI state that is activated is available for selection to be used for a particular communication. The network node may transmit DCI indicating a TCI state to be used for a particular PDSCH resource allocation. The UE can then use the QCL parameters from the relevant TCI state to decode the PDSCH. For a PDCCH, the network node may transmit a MAC control element (MAC-CE) activating a single TCI state for a particular control resource set. The UE can then use the QCL parameters from the single TCI state to decode a PDCCH received in a search space associated with the control resource set.

The activation of TCI states using MAC signaling may be associated with an activation time. The activation time is a length of time measured from when a MAC-CE indicating a TCI state for a beam update (referred to herein as activation signaling) is received to when the UE is to have activated the TCI state. The length of the activation time may be a function of whether the TCI state is “known” to the UE. A TCI state is “known” to the UE if the following conditions are met during the period from the last transmission of the RS resource used for the Layer 1 (L1) reference signal received power (L1-RSRP) measurement reporting for the target TCI state to the completion of an active TCI state switch, where the RS resource for L1-RSRP measurement is the RS in the target TCI state or QCL'ed to the target TCI state: 1) the TCI state switch command (that is, activation signaling) is received within 1280 milliseconds upon the last transmission of the RS resource for beam reporting or measurement; 2) the UE has sent at least one L1-RSRP report for the target TCI state before the TCI state switch command; 3) the TCI state remains detectable during the TCI state switching period; 4) the SSB associated with the TCI state remains detectable during the TCI switching period (for example, the signal-to-noise ratio (SNR) of the TCI state ≥−3 decibels (dB)). If any one of the conditions described above is not met, then the TCI state may be “unknown” to the UE. In such examples, the TCI state may be referred to as an “unknown TCI state.”

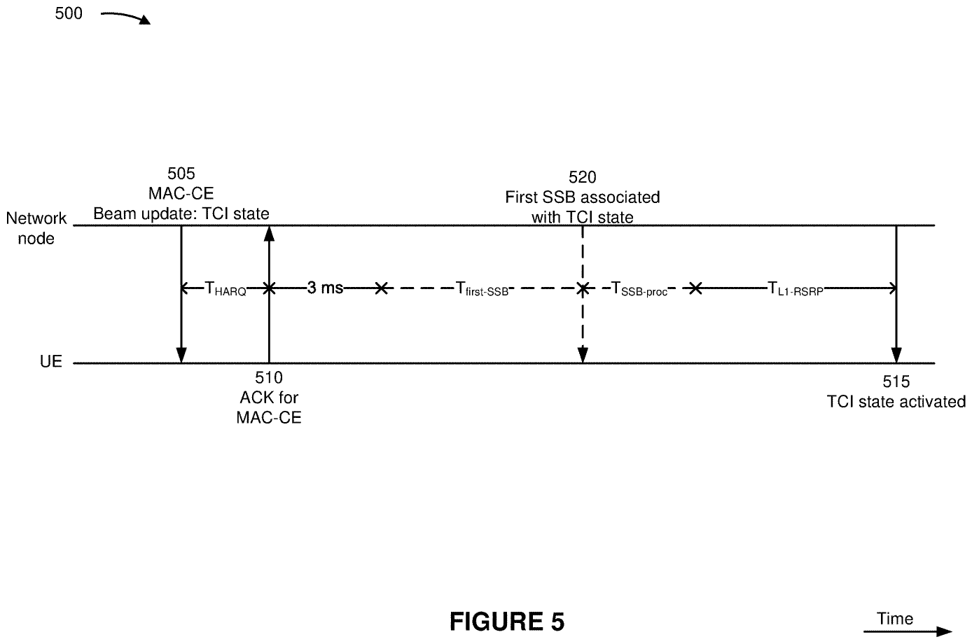

FIG. 5 is a diagram illustrating an example 500 of activating a TCI state in accordance with an activation time, in accordance with the present disclosure. As shown in FIG. 5, a UE (for example, UE 120) and a network node (for example, network node 110). Downlink transmissions are indicated by downward arrows and uplink transmissions are indicated by upward arrows.

As shown in FIG. 5, in a first operation 505, the network node may transmit, and the UE may receive, activation signaling (that is, a MAC-CE beam update, sometimes referred to as a MAC-CE activation command), such as via a PDSCH. The activation signaling may indicate a TCI state to be activated for the UE. For example, the TCI state may be one of a plurality of configured TCI states (not shown in FIG. 5). The TCI state may be a known TCI state or an unknown TCI state (for example, known or unknown to the UE). For example, the TCI state may, or may not, satisfy the conditions to be considered as a known TCI state. The TCI state may be one of a set of TCI states activated as selectable for a PDSCH, or the TCI state may be a TCI state activated for a PDCCH (for example, for a control resource set).

In a second operation 510, the UE may transmit an acknowledgment for the activation signaling after a time interval shown as THARQ. For example, the UE may transmit hybrid automatic repeat request (HARQ) feedback after the time interval.

In a third operation 515, the UE may activate the TCI state (for example, may be mandated to activate the TCI state) after an amount of time. This amount of time is referred to herein as an activation time. The activation time may be based at least in part on whether the TCI state is known to the UE. If the TCI state is known to the UE, then the TCI state may be activated after slot

$$n + {T}_{HARQ} + 3 {N}_{slot}^{subframe , μ} + {TO}_{k} * ( {T}_{first - SSB} + {T}_{SSB - proc} ) / NR slot length ,$$

where T_{HARQ} is the timing between downlink data transmission and acknowledgement,

$$3 {N}_{slot}^{subframe , μ}$$

is a delay to apply the TCI state as defined by a wireless communication specification (for example, 3 ms), T_{first-SSB} is a time to the first SSB transmission after the MAC-CE is decoded by the UE (where the SSB is QCL-TypeA or QCL-TypeC to the target TCI state), T_{SSB-proc}=2 ms, and TOₖ=1 if the target TCI state is not in the active TCI state list for PDSCH and 0 otherwise. The first SSB transmission may be transmitted to the UE in a fourth operation 520, and the MAC-CE, as described above, is received by the UE in the first operation 505.

If the TCI state is unknown to the UE 120, then the TCI state may be activated after n+T_{HARQ}+(3 ms+T_{L1-RSRP}+TOₖ*(T_{first-SSB}+T_{SSB-proc})/NR slot length, where T_{L1-RSRP} is an amount of time associated with L1-RSRP measurements for receive beam refinement, as defined or otherwise fixed by the 3GPP. For example, T_{L1-RSRP} may be an L1-RSRP measurement delay. TOₖ may be equal to 1 for CSI-RS-based L1-RSRP measurements and TOₖ may be equal to 0 for SSB-based L1-RSRP measurements (for example, where the TCI state switching is associated with QCL-TypeD). TOₖ may be equal to 1 for all other QCL types (for example, other than QCL-TypeD). For example, if the TCI state is associated with a CSI-RS and the TCI state is unknown, then the UE may measure an SSB to identify QCL-TypeA and/or QCL-TypeC information for the CSI-RS. The UE may measure the CSI-RS (for example, a CSI-RS configured with repetitions) to refine a receive beam of the UE to be associated with the TCI state. A value of T_{L1-RSRP} may be based at least in part on whether the TCI state is associated with an SSB or a CSI-RS. For example, a wireless communication standard (for example, the 3GPP) may define different values for T_{L1-RSRP} for SSBs and CSI-RSs. The values of T_{L1-RSRP} may be defined, or otherwise fixed, by a wireless communication standard, such as the 3GPP. In some examples, a value of T_{L1-RSRP} may be based at least in part on a quantity of receive beams associated with the UE (for example, may be based on a maxNumberRxBeam capability reported by the UE). For example, the values of the T_{L1-RSRP} may be defined, or otherwise fixed, by 3GPP Technical Specification 38.133 Version 17.7.0 Section 9.5.4. For example, the UE may expect to be scheduled with a CSI-RS resource set that is configured with repetitions prior to switching to an unknown TCI state.

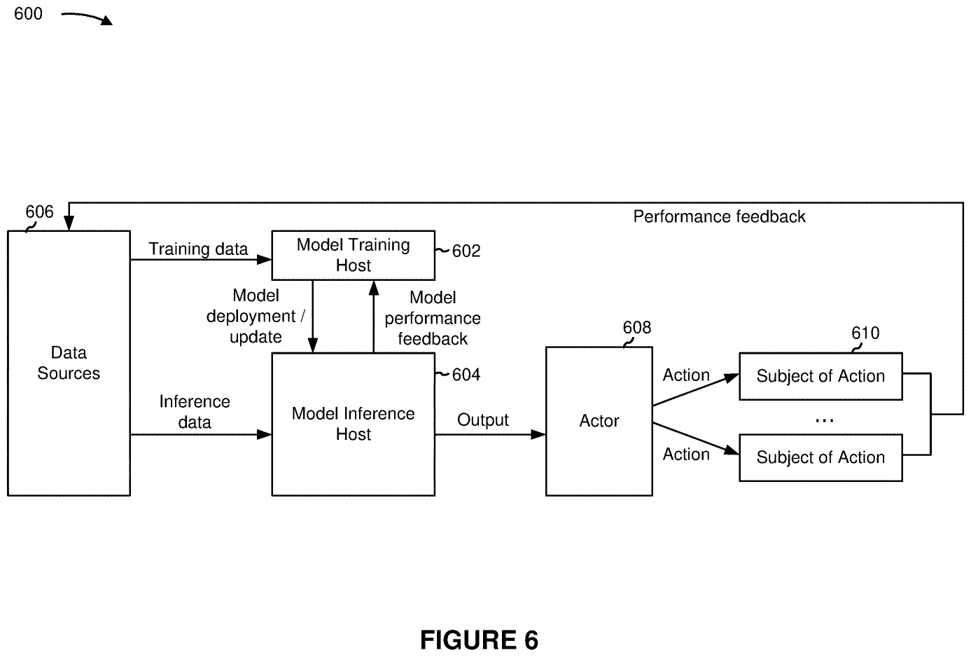

FIG. 6 is a diagram illustrating an example architecture 600 of a functional framework for radio access network (RAN) intelligence enabled by data collection in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (for example, the AI functionality and/or the input/output of the component for AI enabled optimization) have been utilized or studied to identify the benefits of AI enabled RAN through possible use cases (for example, beam management, energy saving, load balancing, mobility management, and/or coverage optimization, among other examples). In one example, as shown by the architecture 600, a functional framework for RAN intelligence may include multiple logical entities, such as a model training host 602, a model inference host 604, data sources 606, and an actor 608.

The model inference host 604 may be configured to run an AI/ML model based on inference data provided by the data sources 606, and the model inference host 604 may produce an output (for example, a prediction) with the inference data input to the actor 608. The actor 608 may be an element or an entity of a core network or a RAN. For example, the actor 608 may be a UE, a network node, base station (for example, a gNB), a CU, a DU, and/or an RU, among other examples. In addition, the actor 608 may also depend on the type of tasks performed by the model inference host 604, type of inference data provided to the model inference host 604, and/or type of output produced by the model inference host 604. For example, if the output from the model inference host 604 is associated with beam management, then the actor 608 may be a UE, a DU or an RU. In other examples, if the output from the model inference host 604 is associated with Tx/Rx scheduling, then the actor 608 may be a CU or a DU.

After the actor 608 receives an output from the model inference host 604, the actor 608 may determine whether to act based on the output. For example, if the actor 608 is a DU or an RU and the output from the model inference host 604 is associated with beam management, the actor 608 may determine whether to change/modify a Tx/Rx beam based on the output. If the actor 608 determines to act based on the output, the actor 608 may indicate the action to at least one subject of action 610. For example, if the actor 608 determines to change/modify a Tx/Rx beam for a communication between the actor 608 and the subject of action 610 (for example, a UE 120), then the actor 608 may transmit a beam (re-)configuration or a beam switching indication to the subject of action 610. The actor 608 may modify its Tx/Rx beam based on the beam (re-)configuration, such as switching to a new Tx/Rx beam or applying different parameters for a Tx/Rx beam, among other examples. As another example, the actor 608 may be a UE and the output from the model inference host 604 may be associated with beam management. For example, the output may be one or more predicted measurement values for one or more beams. The actor 608 (for example, a UE) may determine that a measurement report (for example, a Layer 1 (L1) RSRP report) is to be transmitted to a network node 110.

The data sources 606 may also be configured for collecting data that is used as training data for training an ML model or as inference data for feeding an ML model inference operation. For example, the data sources 606 may collect data from one or more core network and/or RAN entities, which may include the subject of action 610, and provide the collected data to the model training host 602 for ML model training. For example, after a subject of action 610 (for example, a UE 120) receives a beam configuration from the actor 608, the subject of action 610 may provide performance feedback associated with the beam configuration to the data sources 606, where the performance feedback may be used by the model training host 602 for monitoring or evaluating the ML model performance, such as whether the output (for example, prediction) provided to the actor 608 is accurate. In some examples, if the output provided by the actor 608 is inaccurate (or the accuracy is below an accuracy threshold), then the model training host 602 may determine to modify or retrain the ML model used by the model inference host, such as via an ML model deployment/update.

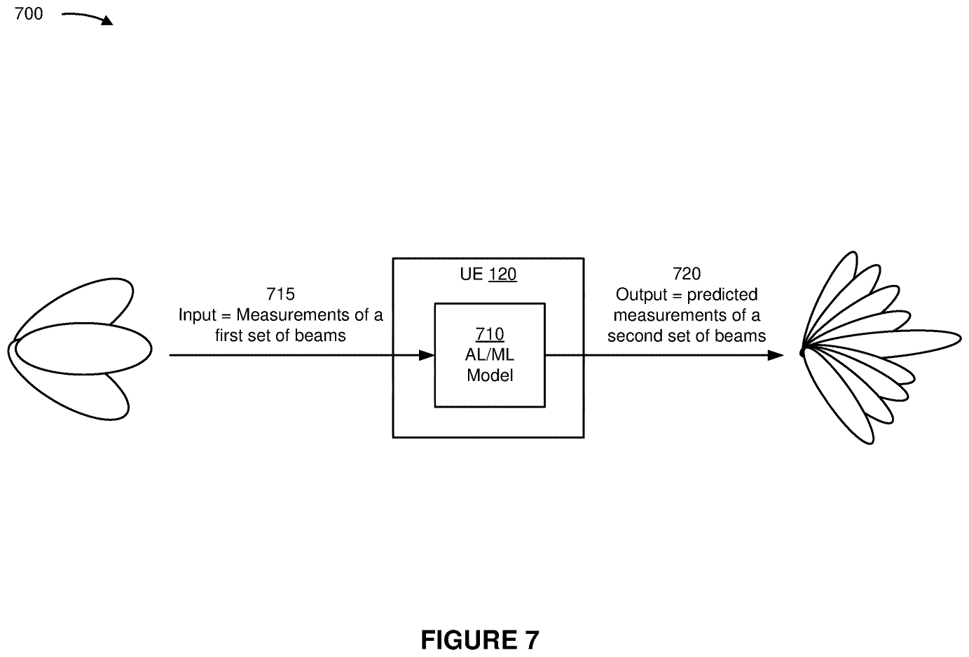

FIG. 7 is a diagram illustrating an example of an AI/ML based beam management 700 in accordance with the present disclosure. As shown in FIG. 7, an AI/ML model 710 may be deployed at or on a UE 120. For example, a model inference host (such as a model inference host) may be deployed at, or on, a UE 120. The AI/ML model 710 may enable the UE 120 to determine one or more inferences or predictions based on data input to the AI/ML model 710.

The AI/ML model 710 may include a neural network model or a neural network function. The neural network model or the neural network function may be trained to output Y based on an input X. For example, as described elsewhere herein, the input X may be measurement values (for example, RSRP measurement values) of one or more beams. The output Y may be predicted measurement values (for example, predicted future measurement values) of the one or more beams and/or of one or more other beams. The neural network may be defined as a model structure and a parameter set. The model structure may include a type of neural network (for example, a convolutional neural network, a recurrent neural network, a feedforward neural network, a modular neural network, and/or another type of neural network), a quantity of layers associated with the neural network, and/or other architectural parameters associated with the neural network. The model structure may be associated with a model structure identifier. The model structure identifier may be a unique identifier (for example, in a wireless network) to enable network nodes, UEs, or other devices to identify the model structure. The model structure may be linked to, or associated with, the neural network function. The neural network function may be linked to, or associated with, the AI/ML model 710. In some examples, the AI/ML model 710 may include, or be associated with, multiple model structures. In some examples, the AI/ML model 710 may include a recurrent neural network, such as a long short-term memory (LSTM) neural network, among other examples.

In some examples, the AI/ML model 710 may be deployed or executed by a network node 110. For example, the network node 110 may train and/or configure the AI/ML model 710 (for example, may select a model structure and/or identify a parameter set). The network node 110 may receive, from a UE 120, one or more measurements associated with a first set of beams. The network node 110 may provide the one or more measurements as an input to the AI/ML model 710. An output of the AI/ML model 710 may include predicted measurement values associated with the first set of beams and/or predicted measurement values associated with a second set of beams. In other examples, the AI/ML model 710 may be deployed or executed by a UE 120. For example, a network node 110 may train and/or configure the AI/ML model 710. The network node 110 may transmit, and the UE 120 may receive, a configuration of the AI/ML model 710 (for example, may receive an indication of a model structure and a parameter set).

For example, in a first operation 715, an input to the AI/ML model 710 may include measurements associated with a first set of beams. For example, a network node 110 may transmit one or more signals using respective beams from the first set of beams. The UE 120 may perform measurements (for example, L1 RSRP measurements or other measurements) of the first set of beams to obtain a first set of measurements. For example, each beam, from the first set of beams, may be associated with one or more measurements performed by the UE 120. The UE 120 may input the first set of measurements (for example, L1 RSRP measurement values) into the AI/ML model 710, along with information associated with the first set of beams and/or a second set of beams, such as a beam direction (for example, spatial direction), beam width, beam shape, and/or other characteristics of the respective beams from the first set of beams and/or the second set of beams.

In a second operation 720, the AI/ML model 710 may output one or more predictions. The one or more predictions may include predicted measurement values (for example, predicted L1 RSRP measurement values) associated with the first set of beams and/or with the second set of beams. For example, the first set of beams and the second set of beams may be the same set of beams, may include one or more common beams, or may be mutually exclusive sets of beams This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook based spatial domain selection or prediction. In examples where the first set of beams and the second set of beams are the same set of beams, the prediction may be referred to as a time domain selection or prediction. As used herein, “predicted beam measurement” and “predicted measurement value” may be used interchangeably. For example, “predicted beam measurement” may refer to a predicted L1-RSRP value or a predicted L1 signal-to-interference-plus-noise ratio (SINR) value, among other examples.

As another example, an output of the AI/ML model 710 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 710. This may enable the AI/ML model 710 to output codebook based and/or non-codebook based predictions for a measurement value, an AoD, and/or an AoA, among other examples, of a beam at a future time. The output(s) of the AI/ML model 710, as described herein, may facilitate initial access procedures, secondary cell group (SCG) setup procedures, beam refinement procedures (for example, a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (for example, the Set B beams) may be a subset of the second set of beams (for example, the Set A beams). In some other examples, the first set of beams and the second set of beams may be different beams and/or may be mutually exclusive sets. For example, the first set of beams (for example, the Set B beams) may include wide beams (for example, unrefined beams or beams having a beam width that satisfies a first threshold) and the second set of beams (for example, the Set A beams) may include narrow beams (for example, refined beams or beams having a beam width that satisfies a second threshold). In one example, the AI/ML model 710 may perform spatial-domain downlink beam predictions for beams included in the Set A beams based on measurement results of beams included in the Set B beams. As another example, the AI/ML model 710 may perform temporal downlink beam prediction for beams included in the Set A beams based on historic measurement results of beams included in the Set B beams.

In some examples, a measurement value that is reported to a network node 110 (for example, by a UE 120) may be associated with a channel measurement resource (CMR). A CMR may be a resource that is configured for a UE 120 for performing measurements of a channel. In some examples, a CMR may include a synchronization signal block (SSB) and/or a channel state information (CSI) reference signal (CSI-RS) (for example, a non-zero power CSI-RS (NZP-CSI-RS)), among other examples. For example, a CMR may be configured with a periodicity at which the CMR is to be transmitted and/or measured (for example, a CMR may be configured with a measurement periodicity of 20 milliseconds, indicating that the UE 120 is to measure the CMR every 20 milliseconds). At a given measurement occasion (for example, a time at which the UE 120 is performing a measurement) for a given CMR, the UE 120 may select a receive beam of the UE 120 to be used to measure the CMR (for example, from M receive beams associated with the UE 120). The UE 120 may select the receive beam based on one or more observations performed by the UE 120, such as previous filtered measurements and/or previous receive beams used by the UE 120, among other examples. In some examples, the UE 120 may use an AI/ML model to select the receive beam. The measurement obtained from measuring the CMR using the receive beam may be a measurement for a beam pair that includes a beam associated with the CMR (for example, a transmit beam of a network node 110 associated with the CMR) and the receive beam. The measurement may be referred to as an instantaneous measurement (for example, an instantaneous RSRP measurement). In some examples, an output of the AI/ML model 710 may include a predicted measurement value that is associated with a given CMR.

The UE 120 may calculate a filtered RSRP value for a given CMR. The filtered RSRP value may indicate an estimated best measurement value (for example, an estimated best RSRP) associated with an estimated best receive beam of the UE 120. The UE 120 may calculate the filtered RSRP value based on instantaneous measurements of the given CMR (for example, associated with different receive beams) over a previous one or more measurement occasions. The UE 120 may transmit, to a network node 110, a measurement report indicating one or more highest filtered measurement values calculated by the UE 120. For example, the UE 120 may indicate the one or more highest filtered measurement values along with respective CMR identifiers of CMRs associated with the one or more highest filtered measurement values. The UE 120 may not include information associated with the receive beams used by the UE 120 in the measurement report. In other words, the UE 120 may not indicate receive beam codebook implementation information to the network node 110. Rather, the UE 120 may store an indication of the receive beam(s) associated with respective CMRs and may use the receive beam(s) to measure the CMRs and/or downlink signals that have a QCL relationship with the CMRs.

In some cases, a UE may operate using different measurement prediction modes. “Measurement prediction modes” may refer to operations performed by a UE associated with predicting one or more measurement values (for example, using the AI/ML model 710). For example, in a first measurement prediction mode, the UE may predict instantaneous measurement values (for example, a predicted measurement value associated with a given CMR and a given measurement occasion). The UE may transmit, to a network node, a measurement report indicating the predicted measurement values (for example, which may be associated with respective receive beams as identified by the UE). The UE may perform filtering of the predicted measurement values to calculate a filtered measurement value for a given CMR (for example, in a similar manner as described above). For example, in the first measurement prediction mode, inputs to the AI/ML model 710 may include previous measurement values (for example, that are measured by the UE or predicted by the UE using the AI/ML model 710) for a given measurement occasion, and receive beam information for a next measurement occasion (for example, a receive beam to be associated with a given CMR in a next measurement occasion). The receive beams may be receive beams that are actually used by the UE to measure a given CMR or may be receive beams that are selected by the UE but not actually used to measure the given CMR (for example, where the UE predicts a measurement value of the given CMR rather than actually measuring the given CMR).

As used herein, a receive beam that is selected by the UE but not actually used to measure a given CMR may be referred to as a “virtual” receive beam. Using the first measurement prediction mode, the UE may obtain filtered measurement values and may identify a best receive beam for each CMR (for example, based on actual measurement values and/or predicted measurement values). Therefore, additional receive beam refinement (for example, additional measurements using various receive beams of the UE) may not be performed for the CMRs.

In a second measurement prediction mode, an output of the AI/ML model 710 may include predicted filtered measurement values. For example, in the second measurement prediction mode, the UE may predict future filtered measurement values. For example, for L CMRs, the input to the AI/ML model 710 may include L filtered measurement values (for example, calculated and/or predicted by the UE) from previous measurement occasions. The output of the AI/ML model 710 may include L predicted filtered measurement values for a future measurement occasion. However, because the UE may not select or determine receive beams for the CMRs for the future measurement occasion (for example, as is done in the first measurement prediction mode), the UE may be unable to derive a best receive beam for each CMR. Therefore, when operating in the second measurement prediction mode, the UE may expect to receive a CSI-RS (for example, that is beamformed by the network node using a same precoder as one or more CMRs), with repetitions to enable the UE to refine and/or select a receive beam for the one or more CMRs (for example, before the UE is switched to an unknown TCI state associated with a QCL-TypeD source reference being a CMR included in the one or more CMRs).

In a third measurement prediction mode, the UE may predict instantaneous measurement values (for example, a predicted measurement value associated with a given CMR and a given measurement occasion). The UE may transmit, to a network node, a measurement report indicating the predicted measurement values (for example, which may be associated with respective receive beams as identified by the UE). The network node (rather than the UE) may perform filtering of the predicted measurement values to calculate a filtered measurement value for a given CMR (for example, in a similar manner as described above). The network node may identify best receive beams (of the UE) for respective CMRs. Therefore, when operating in the third measurement prediction mode, the UE may expect to receive, from the network node, receive beam information associated with an unknown TCI state that is associated with a QCL-TypeD source reference being one of the CMRs (for example, before the UE is switched to the unknown TCI state).

Therefore, as described above, the different measurement prediction modes may be associated with different operations at the UE. As a result, when operating in different measurement prediction modes, the UE may have different levels of information associated with receive beams to be associated with different CMRs. However, the network node may be unaware of a measurement prediction mode in which the UE is operating. In other words, the network node may not know what additional signaling or information is to be transmitted to the UE to enable the UE to properly activate the TCI state. Therefore, the network node may transmit, and the UE may receive, an indication to switch to, or activate, a TCI state. However, the network node may assume (for example, incorrectly) that the UE has stored receive beam information for the TCI state because the UE may have transmitted a measurement report indicating predicted measurement values for a CMR associated with the TCI state (for example, for a CMR that is a QCL-TypeD source reference for the TCI state). Therefore, the network node may not transmit additional signaling (for example, CSI-RSs or receive beam information) associated with the TCI state. In other words, the UE may not receive information enabling the UE to identify a receive beam to be associated with the TCI state. This may result in the UE being unable to receive signals using the TCI state and/or may result in degraded performance associated with signals that are associated with the TCI state (for example, because the UE may use a suboptimal receive beam to receive the signals).

Various aspects relate generally to signaling for measurement prediction modes. Some aspects more specifically relate to a UE transmitting, and a network node receiving, a capability communication indicating one or more measurement prediction modes that are supported by the UE. In some aspects, the network node may transmit, and the UE may receive, an indication to report predicted beam measurements (for example, predicted measurement values) using a measurement prediction mode from the one or more measurement prediction modes. The UE may transmit, and the network node may receive, a measurement report indicating one or more predicted beam measurements, the one or more predicted beam measurements being predicted using the measurement prediction mode.

For example, before the UE is requested to transmit predicted beam measurement values for one or more CMRs (for example, for one or more future measurement occasions), the UE may transmit the capability communication indicating one or more measurement prediction modes that are supported by the UE. In some aspects, the capability communication may indicate a single measurement prediction mode that is used by the UE. After transmitting the capability communication, the network node may transmit, and the UE may receive, a communication requesting the UE to report one or more predicted measurement values in accordance with the indicated measurement prediction mode (for example, the single measurement prediction mode that is used by the UE). Additionally, the network node may transmit, and the UE may receive, additional signaling associated with the measurement prediction mode, such as CSI-RS transmissions and/or receive beam information associated with an unknown TCI state.

The one or more measurement prediction modes may include a first measurement prediction mode associated with not receiving CSI-RS transmissions for an activation of an unknown TCI state, a second measurement prediction mode associated with receiving CSI-RS transmissions for the activation of the unknown TCI state, and/or a third measurement prediction mode associated with the unknown TCI state including receive beam information, among other examples.

Particular aspects of the subject matter described in this disclosure can be implemented to realize one or more of the following potential advantages. In some examples, the described techniques can be used to enable the UE to operate in different measurement prediction modes while also ensuring that the UE receives sufficient signaling or information to select receive beams for different CMRs or TCI states. For example, by signaling a used, supported, and/or preferred measurement prediction mode of the UE, the network node may be enabled to activate an unknown TCI state (for example, that is associated with a CMR that is associated with a predicted measurement value reported by the UE) and to transmit additional signals (for example, one or more CSI-RS transmissions or receive beam information) to enable the UE to identify a best receive beam to be associated with the unknown TCI state.

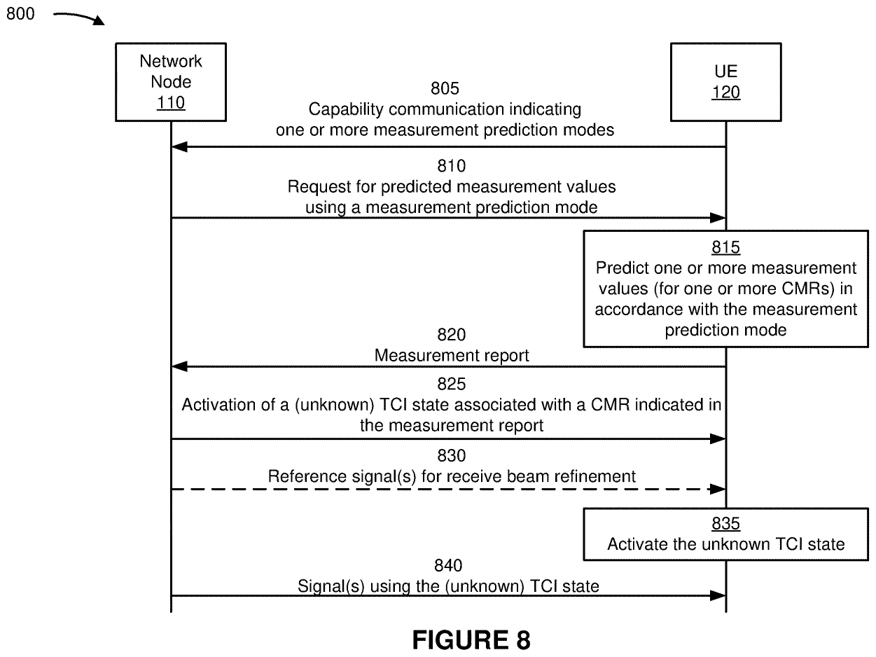

FIG. 8 is a diagram of an example associated with signaling 800 for measurement prediction modes in accordance with the present disclosure. As shown in FIG. 8, a network node 110 (for example, a base station, a CU, a DU, and/or an RU) may communicate with a UE 120. In some aspects, the network node 110 and the UE 120 may be part of a wireless network (for example, the wireless network 100). The UE 120 and the network node 110 may have established a wireless connection prior to operations shown in FIG. 8.

In some aspects, actions described herein as being performed by the network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

In a first operation 805, the UE 120 may transmit, and the network node 110 may receive, a capability communication. The capability communication may include a capability report. In some aspects, the UE 120 may transmit the capability communication via RRC signaling, one or more MAC control elements (MAC-CEs), and/or uplink control information (UCI) signaling, among other examples. In some aspects, the capability communication may be included in a UE assistance information (UAI) communication. In some aspects, the capability communication may be transmitted by the UE 120 via a physical uplink control channel (PUCCH) or a physical uplink shared channel (PUSCH).

In some aspects, the UE 120 may transmit the capability communication as part of an initial access procedure with the network node 110. For example, the UE 120 may transmit the capability communication after completing a random access procedure (for example, a random access channel (RACH) procedure) with the network node 110. As another example, the UE 120 may transmit the capability communication as part of establishing an RRC connection with the network node 110. In other aspects, the UE 120 may transmit the capability communication (and/or an update to the capability communication) after establishing a connection with the network node 110.

The capability communication may indicate one or more measurement prediction modes that are supported by the UE 120. For example, the capability communication may indicate a measurement prediction mode, from the one or more measurement prediction modes, that is being used by the UE 120 to perform predictions of measurement values (for example, for CMRs configured for the UE 120). As another example, the capability communication may indicate a measurement prediction mode, from the one or more measurement prediction modes, that the UE 120 is requesting to use (for example, the capability communication may indicate a preferred measurement prediction mode).

In some aspects, the capability communication may include a respective identifier of each of the one or more measurement prediction modes indicated by the capability communication. For example, a set of measurement prediction modes may be defined (for example, by the network node 110, another network node, or by a wireless communication standard, such as the 3GPP). The UE 120 may receive (for example, from the network node 110) and/or store (for example, as part of an original equipment manufacturer (OEM) configuration) identifiers for respective measurement prediction modes. The UE 120 may indicate a given measurement prediction mode in the capability communication by including an identifier associated with the given measurement prediction mode in the capability communication.

The UE 120 may transmit the capability communication before the UE 120 is requested to report prediction measurement values to the network node 110. In other words, before the UE 120 is actually requested by network node 110 to report predicted L1-RSRP values and/or predicted L1-SINR values, among other examples, associated with one or more CMRs and with respect to one or more future time domain occasions, the UE 120 may pre-report the one or more measurement prediction modes. This may enable the network node 110 to identify which measurement prediction mode(s) is/are available to be used by the UE 120 and/or which measurement prediction mode(s) is/are actually being used by the UE 120. As a result, the network node 110 may identify which signals, which type of signals, a quantity of signals, and/or a content of the signals to be transmitted to the UE 120 to enable the UE 120 to receive signals associated with TCI states that have a QCL relationship (for example, a QCL-TypeD relationship) with CMRs for which the UE 120 predicts one or more measurement values, as described in more detail elsewhere herein.

The one or more measurement prediction modes may be similar to the measurement prediction modes described elsewhere herein. For example, the one or more measurement prediction modes may include a first measurement prediction mode associated with not receiving CSI-RS transmissions for an activation of an unknown TCI state, a second measurement prediction mode associated with receiving CSI-RS transmissions for the activation of the unknown TCI state, and/or a third measurement prediction mode associated with the unknown TCI state including receive beam information, among other examples. For example, in the first measurement prediction mode, the UE 120 may predict instantaneous measurement values (for example, a predicted measurement value associated with a given CMR and a given measurement occasion). The UE 120 may transmit, to a network node, a measurement report indicating the predicted measurement values (for example, which may be associated with respective receive beams as identified by the UE 120). The UE 120 may perform filtering of the predicted measurement values to calculate a filtered measurement value for a given CMR (for example, in a similar manner as described above). For example, in the first measurement prediction mode, inputs to the AI/ML model 710 may include previous measurement values (for example, that are measured by the UE 120 or predicted by the UE 120 using an AI/ML model) for a given measurement occasion, and receive beam information for a next measurement occasion (for example, a receive beam to be associated with a given CMR in a next measurement occasion). The receive beams may be receive beams that are actually used by the UE to measure a given CMR or may be receive beams that are selected by the UE but not actually used to measure the given CMR (for example, where the UE predicts a measurement value of the given CMR rather than actually measuring the given CMR). Therefore, additional receive beam refinement (for example, additional measurements using various receive beams of the UE) may not performed for the CMRs

In the second measurement prediction mode, an output of the AI/ML model may include predicted filtered measurement values. For example, in the second measurement prediction mode, the UE 120 may predict future filtered measurement values. For example, for L CMRs, the input to the AI/ML model 710 may include L filtered measurement values (for example, calculated and/or predicted by the UE 120) from previous measurement occasions. The output of the AI/ML model may include L predicted filtered measurement values for a future measurement occasion. However, because the UE 120 may not select or determine receive beams for the CMRs for the future measurement occasion (for example, as is done in the first measurement prediction mode), the UE may be unable to derive a best receive beam for each CMR. Therefore, when operating in the second measurement prediction mode, the UE 120 may expect to receive a CSI-RS (for example, that is beamformed by the network node using a same precoder as one or more CMRs), with repetitions to enable the UE 120 to refine and/or select a receive beam for the one or more CMRs (for example, before the UE 120 is switched to an unknown TCI state associated with a QCL-TypeD source reference being a CMR included in the one or more CMRs).

In the third measurement prediction mode, the UE 120 may predict instantaneous measurement values (for example, a predicted measurement value associated with a given CMR and a given measurement occasion). The UE 120 may transmit, to the network node 110, a measurement report indicating the predicted measurement values (for example, which may be associated with respective receive beams as identified by the UE 120). The network node 110 (rather than the UE 120) may perform filtering of the predicted measurement values to calculate a filtered measurement value for a given CMR (for example, in a similar manner as described above). The network node may identify best receive beams (of the UE 120) for respective CMRs. Therefore, when operating in the third measurement prediction mode, the UE 120 may expect to receive, from the network node 110, receive beam information associated with an unknown TCI state that is associated with a QCL-TypeD source reference being one of the CMRs (for example, before the UE is switched to the unknown TCI state).

As described elsewhere herein, the UE 120 may transmit the capability communication during initial access. In other words, the capability communication may be, or may be included in, a radio resource control communication that is associated with initial access with the network node 110. The UE 120 may expect to be configured with CSI reports that are associated with report quantities that include predicted future measurement values (for example, predicted future L1-RSRPs/L1-SINRs), in accordance with the reported measurement prediction mode(s). Additionally or alternatively, the UE 120 may expect to be signaled with information and/or reference signals in accordance with the reported measurement prediction mode(s). For example, the UE 120 may expect to receive and/or be configured with CSI-RS resources with repetitions configured as on (for example, for the second measurement prediction mode) or receive beam information in a TCI state (for example, for the third measurement prediction mode), among other examples.

In some aspects, the UE 120 may dynamically update the reported measurement prediction mode(s) (for example, after initial access). For example, during initial access, the UE 120 may report a first set of (one or more of) measurement prediction modes. The UE 120 may transmit, and the network node 110 may receive, a communication updating the first set of one or more measurement prediction modes that are supported by the UE 120 to a second set of one or more measurement prediction modes. The communication (for example, updating the measurement prediction mode(s) supported and/or used by the UE 120) may be a MAC-CE communication or a UCI communication, among other examples.

In some aspects, the UE 120 may continue to follow previously reported measurement prediction modes (for example, after transmitting the communication updating the measurement prediction mode(s)) until configured CSI reports are deactivated. For example, before the UE 120 is deactivated with CSI reports associated with report quantities that include predicted future measurement values (for example, where a configuration of the CSI reports violates or does not align with the dynamically updated measurement prediction mode(s)), the UE 120 may still follow the currently activated CSI reports. In other words, if the UE 120 is configured to use a measurement prediction mode that is included in the first set of one or more measurement prediction modes, but is not included in the second set of one or more measurement prediction modes, then the measurement prediction mode may be supported by the UE 120 until CSI report configuration(s) associated with a measurement report is/are deactivated. Additionally, before the UE 120 receives further signaling that the UE 120 would expect (or no longer expect) to be signaled with (such as CSI-RS resource with repetition=on or receive beam information in a TCI state), the UE 120 may still not expect (or still expect) such signaling schemes from the network node 110. In other words, if the UE 120 dynamically updates the supported or used measurement prediction modes, then the UE 120 may continue to support and/or use previously indicated measurement prediction modes until CSI reports (for example, that were configured prior to the UE 120 transmitting the communication updating the measurement prediction mode(s) used or supported) are deactivated.

In a second operation 810, the network node 110 may transmit, and the UE 120 may receive, a request for predicted measurement values. For example, the network node 110 may transmit, and the UE 120 may receive, an indication to report predicted beam measurements using a measurement prediction mode from the one or more measurement prediction modes. In some aspects, the request may include a configuration of a CSI report where the configuration indicates that a report quantity of the CSI report includes one or more predicted measurement values (for example, where the report quantity of the CSI report includes a predicted future L1-RSRP value or a predicted future L1-SINR value, among other examples). For example, a CSI reporting configuration (CSIReportConfig or a CSI report setting) for a CSI report may include a report quantity (reportQuantity) information element that indicates the quantities or parameters that are to be reported in the CSI report. If the report quantity includes predicted measurement values, then the UE 120 may identify the request for predicted measurement values.

In some aspects, the request for predicted measurement values may include an indication of the measurement prediction mode (for example, from the one or more measurement prediction modes reported by the UE 120 in the first operation 805) to be used by the UE 120 to perform the measurement predictions. In other aspects, the request for predicted measurement values may not include an indication of the measurement prediction mode. Rather, the UE 120 and the network node 110 may assume that the UE 120 is using a measurement prediction mode that is reported by the UE 120 in the first operation 805.

In a third operation 815, the UE 120 may predict one or more measurement values (for example, for one or more CMRs in one or more future time domain occasions) in accordance with the measurement prediction mode. For example, the network node 110 may transmit, and the UE 120 may receive, one or more reference signals. For example, the reference signals may be SSBs, CSI-RSs, or another type of reference signal. The reference signals may be associated with an input of the beam prediction model. The UE 120 may perform measurements of the signals that are associated with the reference signals. For example, the UE 120 may perform L1 RSRP measurements and/or L1 SINR measurements, among other examples, of the signals that are associated with the reference signals. For example, the UE 120 may measure the one or more reference signals to obtain a set of measurement values. The UE 120 may input measurement value(s) of the one or more reference signals into the AI/ML model (such as the AI/ML model 710). The UE 120 may obtain an output of the beam prediction model based at least in part on inputting the measurement value(s) of the one or more reference signals. The output of the AI/ML model may include measurement value predictions associated with one or more CMRs (for example, associated with one or more beams). Based at least in part on the measurement prediction mode being used by the UE 120, the output of the AI/ML model may include instantaneous predicted measurement values and/or filtered predicted measurement values.

In a fourth operation 820, the UE 120 may transmit, and the network node 110 may receive, a measurement report indicating one or more predicted beam measurements (for example, one or more predicted measurement values). In some aspects, the one or more predicted beam measurements may be predicted by the UE 120 using the measurement prediction mode (for example, in the third operation 815). For example, the measurement report may be a CSI report. In some aspects, the one or more predicted measurement values may be associated with respective CMRs (for example, from a set of CMRs configured for the measurement report). In some aspects, the one or more predicted measurement values may be instantaneous predicted measurement values (for example, if the UE 120 is operating using the first measurement prediction mode or the third measurement prediction mode). In other examples, the one or more predicted measurement values may be filtered predicted measurement values (for example, if the UE 120 is operating using the second measurement prediction mode).

In a fifth operation 825, the network node 110 may transmit, and the UE 120 may receive, a communication activating a TCI state. For example, the network node 110 may transmit, and the UE 120 may receive, a MAC-CE indicating that the TCI state is to be activated. In some aspects, the network node 110 may transmit, and the UE 120 may receive, a DCI communication indicating the TCI state. The TCI state may be unknown to the UE 120 (for example, the TCI state may be an unknown TCI state, as described in more detail elsewhere herein). The TCI state may be associated with a CMR. For example, a QCL-TypeD source reference for the TCI state may be the CMR. The CMR may be associated with the measurement report (for example, transmitted by the UE 120 in the fourth operation 820). For example, the CMR may be associated with one or more predicted measurement values that are indicated in the measurement report.

The network node 110 may determine additional content and/or signaling to be transmitted to the UE 120 based at least in part on the measurement prediction mode used by the UE 120 (for example, in the third operation 815 and/or the fourth operation 820) and based at least in part on activating an unknown TCI state that is associated with a CMR that is associated with a predicted measurement value reported by the UE 120. For example, if the measurement prediction mode is the first measurement prediction mode, then the network node 110 may determine that no additional content and/or signaling is be transmitted to the UE 120 (for example, no additional content and/or signaling in addition to defined procedures for activating an unknown TCI state).

As another example, if the measurement prediction mode is the second measurement prediction mode, then the network node 110 may determine that CSI-RSs configured with repetitions on are to be transmitted to the UE 120. For example, the network node 110 may transmit, and the UE 120 may receive, a communication scheduling or activating a CSI-RS resource set that is configured with repetitions=on (for example, that is scheduled to be transmitted to the UE 120 before the UE 120 is to switch to the unknown TCI state). For example, the network node 110 may transmit, and the UE 120 may receive, an indication of a CSI-RS resource set that is associated with repetitions to be associated with the unknown TCI state. The CSI-RS resource set may be associated with the same precoder and/or transmit spatial filter as the CMR (for example, as the QCL-TypeD source reference for the unknown TCI state).

For example, in a sixth operation 830, the network node 110 may transmit, and the UE 120 may receive, one or more downlink reference signals for beam refinement at the UE 120. For example, the one or more downlink reference signals may be transmitted by the network node 110 using the same precoder and/or transmit spatial filter as the CMR (for example, as the QCL-TypeD source reference for the unknown TCI state). The one or more downlink reference signals may be SSBs and/or CSI-RSs. For example, the network node 110 may transmit, and the UE 120 may receive, one or more CSI-RSs associated with the CSI-RS resource set. As another example, the UE 120 may receive one or more SSBs associated with the unknown TCI state. The UE 120 may perform measurements of the one or more downlink reference signals using one or more (or all) receive beams of the UE 120. For example, if the UE 120 is associated with N receive beams, then the network node 110 may transmit N repetitions of the one or more downlink reference signals to enable the UE 120 to perform measurements using each of the N receive beams of the UE 120 (for example, to identify a best receive beam to be associated with the unknown TCI state). A value of N may be defined, or otherwise fixed, by a wireless communication standard, such as the 3GPP. Additionally or alternatively, a value of N may be based at least in part on a capability of the UE 120, such as a maxNumberRxBeam capability. For example, the UE 120 may receive a configuration or scheduling information for a CSI-RS set that is associated with the quantity of repetitions (for example, N repetitions). The quantity of repetitions may be based at least in part on a quantity of receive beams of the UE 120 (for example, a maxNumberRxBeam capability) or a quantity of SSB cycles (for example, that is defined by the 3GPP), among other examples.

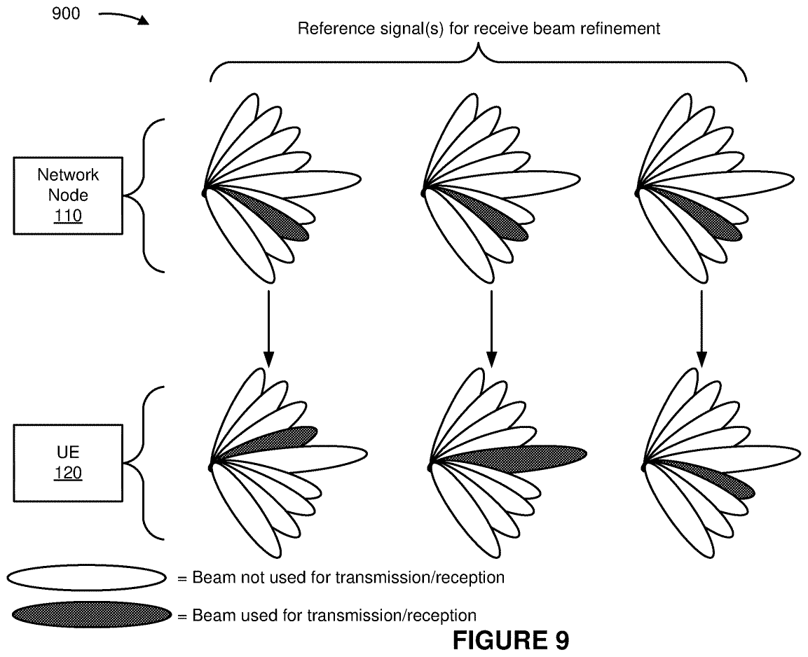

In some aspects, the UE 120 may transmit, and the network node 110 may receive, an indication of a quantity of repetitions to be associated with the CSI-RS transmissions and/or SSB transmissions (for example, a quantity of repetitions to be associated with the sixth operation 830). For example, although the UE 120 may not be able to directly identify the appropriate receive beam for the unknown TCI state (for example, when operating in the second measurement prediction mode), the UE 120 may identify a reduced quantity of candidate receive beams (for example, based at least in part on previous measurements and/or predictions performed by the UE 120). Therefore, the UE 120 may report an indication of a quantity of repetitions to be associated with receive beam refinement for the unknown TCI state. The quantity of repetitions may be less than N (for example, may be less than the quantity of SSB cycles (for example, that is defined by the 3GPP) or may be less than the maxNumberRxBeam of the UE 120). For example, the UE 120 may transmit, and the network node 110 may receive, a capability (for example, in the capability communication or in a similar communication) of a maxNumberRxBeamPrediction capability indicating the quantity of repetitions to be associated with activating an unknown TCI state when the second measurement prediction mode is used by the UE 120. The UE 120 may identify the quantity of occasions of a CSI-RS resource sets based on (maxNumberRxBeamPrediction/N_{res_per_set}), where N_{res_per_set} is the quantity of CSI-RS resources within the CSI-RS resource set. Therefore, the network node 110 may transmit, and the UE 120 may receive, fewer repetitions of the downlink reference signal. This may conserve network resources, processing resources, and/or power resources that would have otherwise been associated with communicating N repetitions of the downlink reference signal. Additionally, this may reduce an amount of time before the unknown TCI state can be activated (for example, may reduce an amount of time associated with T_{L1-RSRP}). The reduced quantity of repetitions for the downlink reference signals is depicted and described in more detail in connection with FIG. 9.

As another example, if the measurement prediction mode is the third measurement prediction mode, then the network node 110 may determine that indication of the unknown TCI state is to include receive beam information (for example, of the UE 120) to be associated with the unknown TCI state. For example, the network node 110 may transmit, and the UE 120 may receive, a first communication activating the unknown TCI state, the unknown TCI state being associated with the CMR (for example, in the fifth operation 825). In some aspects, the unknown TCI state may include information associated with a receive beam (for example, that is identified or selected by the network node 110) to be associated with the unknown TCI state.

As another example, the unknown TCI state may include information associated with a set of receive beams. For example, the network node 110 may identify a subset of receive beams, from a set of receive beams associated with the UE 120, that are candidates to be associated with the unknown TCI state. In such examples, the network node 110 may transmit, and the UE 120 may receive, a second communication scheduling a data communication associated with the unknown TCI state, the second communication indicating a receive beam, from the set (or subset) of receive beams (for example, indicating a receive beam from the set of receive beams indicated by the first communication activating the unknown TCI state). For example, the network node 110 may transmit a MAC-CE communication activating the unknown TCI state where the MAC-CE communication indicates a set of receive beams that are candidates to be associated with the unknown TCI state. The network node 110 may transmit, and the UE 120 may receive, DCI scheduling a data communication to be associated with the unknown TCI state. The DCI may include an indication of a receive beam, from the set of receive beams indicated by the MAC-CE communication. The UE 120 may use the indicated receive beam to receive the data communication. This reduces an indication overhead (for example, a size) needed to indicate the receive beam information in the DCI because the DCI may only point to receive beam information indicated by the MAC-CE communication. In some aspects, a separate MAC-CE that is different than MAC-CEs activating conventional TCI states may be used to activate the unknown TCI state (for example, to indicate one or more receive beams in the MAC-CE). Additionally or alternatively, a dedicated DCI format and/or dedicated radio network temporary identifier (RNTI) for scrambling the DCI may be used for the DCI that indicates the receive beam to be associated with the unknown TCI state.

In a seventh operation 835, the UE 120 may activate the unknown TCI state (for example, that is associated with a CMR for which the UE 120 performed predicted measurements). For example, the UE 120 may activate the unknown TCI state after an amount of time (for example, in a similar manner as described in connection with FIG. 5). In an eighth operation 840, the network node 110 may transmit, and the UE 120 may receive, one or more communications (for example, one or more data communications) associated with the TCI state (for example, the unknown TCI state that was activated by the UE 120 in the seventh operation 835). The UE 120 may receive the one or more communications using a receive beam. The receive beam may be selected or identified by the UE 120 based at least in part on the measurement prediction mode used by the UE 120. For example, if the first measurement prediction mode is used by the UE 120, then the UE 120 may identify the receive beam based at least in part on calculating a filtered RSRP for the CMR associated with the unknown TCI state. If the second measurement prediction mode is used by the UE 120, then the UE 120 may identify the receive beam based at least in part on measurement(s) of the one or more repetitions of a downlink reference signal (for example, in the sixth operation 830) and selecting the receive beam with the highest measurement value. If the second measurement prediction mode is used by the UE 120, then the UE 120 may identify the receive beam based at least in part on receive beam information indicated by the unknown TCI state.

As a result, the UE 120 may be enabled to operate in different measurement prediction modes while also receiving sufficient signaling or information to select receive beams for different CMRs or TCI states. For example, by signaling a used, supported, and/or preferred measurement prediction mode of the UE 120, the network node 110 may be enabled to activate an unknown TCI state (for example, that is associated with a CMR that is associated with a predicted measurement value reported by the UE 120) and to transmit additional signals (for example, one or more CSI-RS transmissions or receive beam information) to enable the UE 120 to identify a best receive beam to be associated with the unknown TCI state.

FIG. 9 is a diagram of an example 900 associated with signaling for measurement prediction modes in accordance with the present disclosure. As shown in FIG. 9, a network node 110 (for example, a base station, a CU, a DU, and/or an RU) may communicate with a UE 120. The signaling may be associated with the sixth operation 830 described above in connection with FIG. 8.

For example, typically, for unknown TCI states, the network node 110 may transmit, and the UE 120 may receive, repetitions of a downlink reference signal (for example, an SSB or a CSI-RS), where a quantity of the repetitions is equal to, or based at least in part on, a quantity of receive beams associated with the UE 120. However, where an unknown TCI state has a QCL-TypeD source reference that is a CMR associated with a predicted measurement value, the unknown TCI state may be said to be “semi-known” by the UE 120. In other words, the UE 120 may have some information based at least in part on performing the measurement predictions associated with the CMR, but may not have full information to enable the UE 120 to identify a best receive beam to be associated with the “semi-known” TCI state. However, because the UE 120 may have some information associated with the TCI state, the network node 110 may transmit fewer repetitions of the downlink reference signal than would otherwise be the case for an unknown TCI state. For example, the UE 120 may transmit, and the network node 110 may receive, an indication of a quantity of SSB cycles, a quantity of receive beams, and/or a quantity of CSI-RS cycles to be associated with “semi-known” TCI states (for example, TCI states associated with CMRs that are associated with predicted measurement values).

For example, as shown in FIG. 9, the UE 120 may be associated with nine receive beams. Rather than the network node 110 transmitting repetitions to enable the UE 120 may measure a downlink reference signal using each of the nine receive beams, the network node 110 may transmit three repetitions of the downlink reference signal and the UE 120 may measure the downlink reference signal using three of the nine receive beams. For example, the reported value by the UE 120 may be three (for example, for TCI states associated with CMRs that are associated with predicted measurement values may be three). Therefore, a signaling overhead and/or an amount of time (for example, a T_{L1-RSRP}) associated with activating an unknown TCI state may be reduced.

FIG. 10 is a flowchart illustrating an example process 1000 performed, for example, by a UE that supports signaling for measurement prediction modes in accordance with the present disclosure. Example process 1000 is an example where the UE (for example, the UE 120) performs operations associated with signaling for measurement prediction modes.

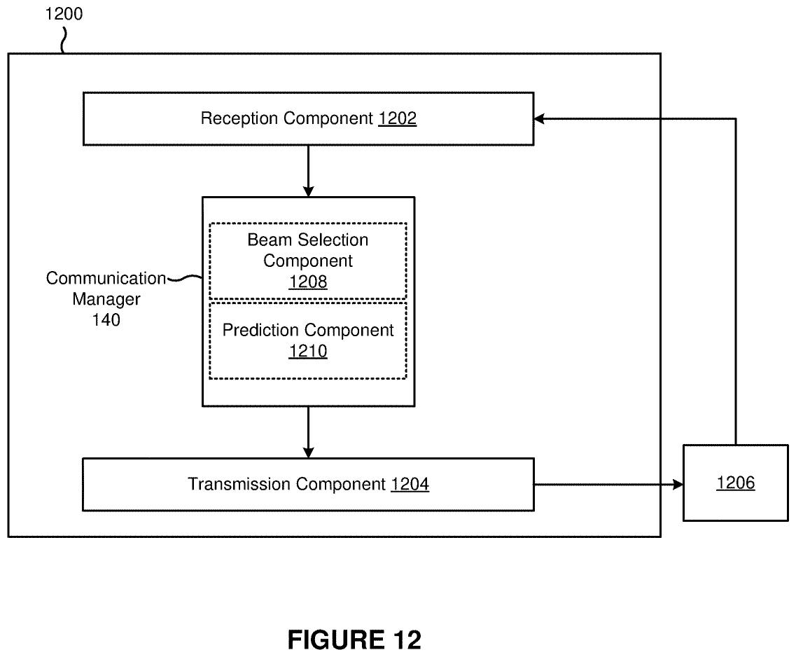

As shown in FIG. 10, in some aspects, process 1000 may include transmitting, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information (block 1010). For example, the UE (such as by using communication manager 140 or transmission component 1204, depicted in FIG. 12) may transmit, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information, as described above.

As further shown in FIG. 10, in some aspects, process 1000 may include receiving, from the network node, an indication to report predicted beam measurements using a measurement prediction mode from the one or more measurement prediction modes (block 1020). For example, the UE (such as by using communication manager 140 or reception component 1202, depicted in FIG. 12) may receive, from the network node, an indication to report predicted beam measurements using a measurement prediction mode from the one or more measurement prediction modes, as described above.

As further shown in FIG. 10, in some aspects, process 1000 may include transmitting, to the network node, a measurement report indicating one or more predicted beam measurements, the one or more predicted beam measurements being predicted using the measurement prediction mode (block 1030). For example, the UE (such as by using communication manager 140 or transmission component 1204, depicted in FIG. 12) may transmit, to the network node, a measurement report indicating one or more predicted beam measurements, the one or more predicted beam measurements being predicted using the measurement prediction mode, as described above.

Process 1000 may include additional aspects, such as any single aspect or any combination of aspects described below or in connection with one or more other processes described elsewhere herein.

In a first additional aspect, the capability communication includes a respective identifier of each of the one or more measurement prediction modes.

In a second additional aspect, alone or in combination with the first aspect, the measurement prediction mode is the first measurement prediction mode, and process 1000 includes receiving, from the network node, a communication activating the unknown TCI state, the unknown TCI state being associated with a channel measurement resource indicated in the measurement report, and receiving, using a receive beam associated with the channel measurement resource that is associated with the predicted beam measurements, one or more signals associated with the unknown TCI state.

In a third additional aspect, alone or in combination with one or more of the first and second aspects, the measurement prediction mode is the second measurement prediction mode, and process 1000 includes receiving, from the network node, a communication activating the unknown TCI state, the unknown TCI state being associated with a channel measurement resource indicated in the measurement report, the channel measurement resource being a QCL source resource for the unknown TCI state, receiving, from the network node, an indication of a CSI-RS resource set that is associated with repetitions to be associated with the unknown TCI state, and receiving, from the network node, one or more CSI-RSs associated with the CSI-RS resource set, and receiving, using a receive beam that is based at least in part on measurements of the one or more CSI-RSs, one or more signals associated with the unknown TCI state.

In a fourth additional aspect, alone or in combination with one or more of the first through third aspects, the measurement prediction mode is the third measurement prediction mode, and process 1000 includes receiving, from the network node, a communication activating the unknown TCI state, the unknown TCI state being associated with a channel measurement resource indicated in the measurement report, and receiving, using a receive beam that is based at least in part on the receive beam information, one or more signals associated with the unknown TCI state.

In a fifth additional aspect, alone or in combination with one or more of the first through fourth aspects, the capability communication is a radio resource control communication that is associated with initial access with the network node.

In a sixth additional aspect, alone or in combination with one or more of the first through fifth aspects, the one or more measurement prediction modes include a first set of one or more measurement prediction modes, and process 1000 includes transmitting, to the network node, a communication updating the first set of one or more measurement prediction modes that are supported by the UE to a second set of one or more measurement prediction modes.

In a seventh additional aspect, alone or in combination with one or more of the first through sixth aspects, the measurement prediction mode is not included in the second set of measurement prediction modes, and the measurement prediction mode is supported by the UE until a CSI report configuration associated with the measurement report is deactivated.

In an eighth additional aspect, alone or in combination with one or more of the first through seventh aspects, the measurement prediction mode is the second measurement prediction mode, and process 1000 includes transmitting, to the network node, an indication of a quantity of repetitions to be associated with the CSI-RS transmissions, receiving, from the network node, a communication activating the unknown TCI state, the unknown TCI state being associated with a channel measurement resource indicated in the measurement report, and receiving, from the network node, a configuration or scheduling information for a CSI-RS set that is associated with the quantity of repetitions.

In a ninth additional aspect, alone or in combination with one or more of the first through eighth aspects, the indication of the quantity of repetitions includes an indication of at least one of a quantity of receive beams, or a quantity of SSB cycles.

In a tenth additional aspect, alone or in combination with one or more of the first through ninth aspects, the measurement prediction mode is the third measurement prediction mode, and process 1000 includes receiving, from the network node, a first communication activating the unknown TCI state, the unknown TCI state being associated with a channel measurement resource indicated in the measurement report, the unknown TCI state including information associated with a set of receive beams, receiving, from the network node, a second communication scheduling a data communication associated with the unknown TCI state, the second communication indicating a receive beam, from the set of receive beams, and receiving, using the receive beam, the data communication.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a network node that supports signaling for measurement prediction modes in accordance with the present disclosure. Example process 1100 is an example where the network node (for example, network node 110) performs operations associated with signaling for measurement prediction modes.

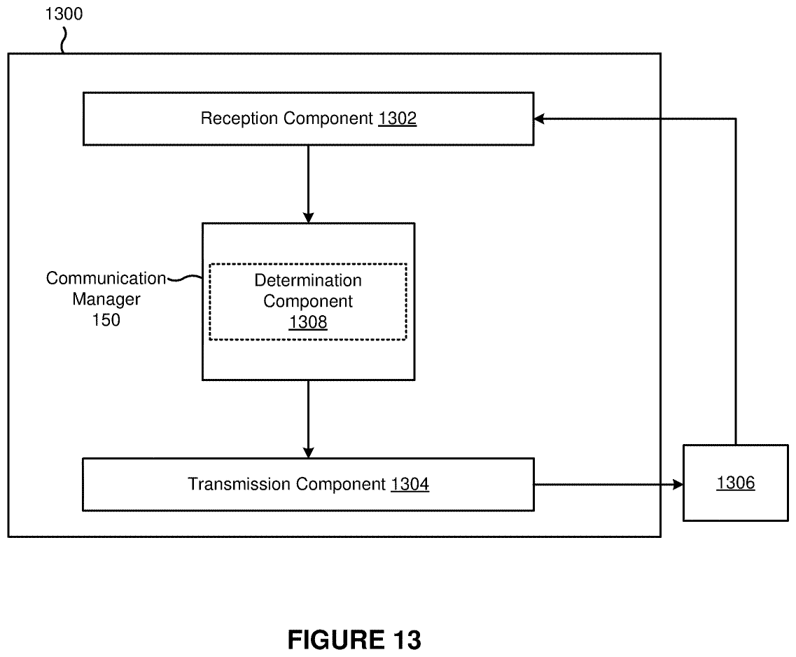

As shown in FIG. 11, in some aspects, process 1100 may include receiving a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information (block 1110). For example, the network node (such as by using communication manager 150 or reception component 1302, depicted in FIG. 13) may receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information, as described above.

As further shown in FIG. 11, in some aspects, process 1100 may include transmitting an indication for the UE to report predicted beam measurements using a measurement prediction mode from the one or more measurement prediction modes (block 1120). For example, the network node (such as by using communication manager 150 or transmission component 1304, depicted in FIG. 13) may transmit an indication for the UE to report predicted beam measurements using a measurement prediction mode from the one or more measurement prediction modes, as described above.

As further shown in FIG. 11, in some aspects, process 1100 may include receiving a measurement report associated with the UE indicating one or more predicted beam measurements, the one or more predicted beam measurements being predicted using the measurement prediction mode (block 1130). For example, the network node (such as by using communication manager 150 or reception component 1302, depicted in FIG. 13) may receive a measurement report associated with the UE indicating one or more predicted beam measurements, the one or more predicted beam measurements being predicted using the measurement prediction mode, as described above.

Process 1100 may include additional aspects, such as any single aspect or any combination of aspects described below or in connection with one or more other processes described elsewhere herein.

In a first additional aspect, the capability communication includes a respective identifier of each of the one or more measurement prediction modes.

In a second additional aspect, alone or in combination with the first aspect, the measurement prediction mode is the first measurement prediction mode, and process 1100 includes transmitting a communication activating the unknown TCI state, the unknown TCI state being associated with a channel measurement resource indicated in the measurement report, and transmitting one or more signals associated with the unknown TCI state.

In a third additional aspect, alone or in combination with one or more of the first and second aspects, the measurement prediction mode is the second measurement prediction mode, and process 1100 includes transmitting a communication activating the unknown TCI state, the unknown TCI state being associated with a channel measurement resource indicated in the measurement report, the channel measurement resource being a QCL source resource for the unknown TCI state, transmitting an indication of a CSI-RS resource set that is associated with repetitions to be associated with the unknown TCI state, and transmitting one or more CSI-RSs associated with the CSI-RS resource set, and transmitting one or more signals associated with the unknown TCI state.

In a fourth additional aspect, alone or in combination with one or more of the first through third aspects, the measurement prediction mode is the third measurement prediction mode, and process 1100 includes transmitting a communication activating the unknown TCI state, the unknown TCI state being associated with a channel measurement resource indicated in the measurement report, and transmitting one or more signals associated with the unknown TCI state.

In a fifth additional aspect, alone or in combination with one or more of the first through fourth aspects, the capability communication is a radio resource control communication that is associated with initial access with the network node.

In a sixth additional aspect, alone or in combination with one or more of the first through fifth aspects, the one or more measurement prediction modes include a first set of one or more measurement prediction modes, and process 1100 includes receiving a communication updating the first set of one or more measurement prediction modes that are supported by the UE to a second set of one or more measurement prediction modes.

In a seventh additional aspect, alone or in combination with one or more of the first through sixth aspects, the measurement prediction mode is not included in the second set of measurement prediction modes, and the measurement prediction mode is supported by the UE until a CSI report configuration associated with the measurement report is deactivated.

In an eighth additional aspect, alone or in combination with one or more of the first through seventh aspects, the measurement prediction mode is the second measurement prediction mode, and process 1100 includes receiving an indication of a quantity of repetitions to be associated with the CSI-RS transmissions, and transmitting a communication activating the unknown TCI state, the unknown TCI state being associated with a channel measurement resource indicated in the measurement report, and transmitting a configuration or scheduling information for a CSI-RS set that is associated with the quantity of repetitions.

In a ninth additional aspect, alone or in combination with one or more of the first through eighth aspects, the indication of the quantity of repetitions includes an indication of at least one of a quantity of receive beams, or a quantity of SSB cycles.

In a tenth additional aspect, alone or in combination with one or more of the first through ninth aspects, the measurement prediction mode is the third measurement prediction mode, and process 1100 includes transmitting a first communication activating the unknown TCI state, the unknown TCI state being associated with a channel measurement resource indicated in the measurement report, the unknown TCI state including information associated with a set of receive beams, transmitting a second communication scheduling a data communication associated with the unknown TCI state, the second communication indicating a receive beam, from the set of receive beams, and transmitting the data communication.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports signaling for measurement prediction modes in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to perform one or more operations described herein in connection with FIGS. 8 and 9. Additionally or alternatively, the apparatus 1200 may be configured to perform one or more processes described herein, such as process 1000 of FIG. 10. In some aspects, the apparatus 1200 may include one or more components of the UE described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the UE described above in connection with FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the UE described above in connection with FIG. 2. In some aspects, the transmission component 1204 may be co-located with the reception component 1202 in a transceiver.

The communication manager 140 may transmit or may cause the transmission component 1204 to transmit, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The communication manager 140 may receive or may cause the reception component 1202 to receive, from the network node, an indication to report predicted beam measurements using a measurement prediction mode from the one or more measurement prediction modes. The communication manager 140 may transmit or may cause the transmission component 1204 to transmit, to the network node, a measurement report indicating one or more predicted beam measurements, the one or more predicted beam measurements being predicted using the measurement prediction mode. In some aspects, the communication manager 140 may perform one or more operations described elsewhere herein as being performed by one or more components of the communication manager 140.

The communication manager 140 may include a controller/processor, a memory, t of the UE described above in connection with FIG. 2. In some aspects, the communication manager 140 includes a set of components, such as a beam selection component 1208, and/or a prediction component 1210. Alternatively, the set of components may be separate and distinct from the communication manager 140. In some aspects, one or more components of the set of components may include or may be implemented within a controller/processor, a memory, t of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1204 may transmit, to a network node, a capability communication indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The reception component 1202 may receive, from the network node, an indication to report predicted beam measurements using a measurement prediction mode from the one or more measurement prediction modes. The transmission component 1204 may transmit, to the network node, a measurement report indicating one or more predicted beam measurements, the one or more predicted beam measurements being predicted using the measurement prediction mode.

The beam selection component 1208 may select a receive beam to be associated with the unknown TCI state. The beam selection component 1208 may select the receive beam based at least in part on measurements of the CSI-RS transmissions. The beam selection component 1208 may select the receive beam based at least in part on the receive beam information.

The prediction component 1210 may predict the one or more predicted beam measurements. In some aspects, the prediction component 1210 may input information into an AI/ML model to obtain the one or more predicted beam measurements.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports signaling for measurement prediction modes in accordance with the present disclosure. The apparatus 1300 may be a network node, or a network node may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to perform one or more operations described herein in connection with FIGS. 8 and 9. Additionally or alternatively, the apparatus 1300 may be configured to perform one or more processes described herein, such as process 1100 of FIG. 11. In some aspects, the apparatus 1300 may include one or more components of the network node described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, and/or a memory of the network node described above in connection with FIG. 2.

The transmission component 1304 may transmit communications, such as reference signals, control information, and/or data communications, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, and/or a memory of the network node described above in connection with FIG. 2. In some aspects, the transmission component 1304 may be co-located with the reception component 1302 in a transceiver.

The communication manager 150 may receive or may cause the reception component 1302 to receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The communication manager 150 may transmit or may cause the transmission component 1304 to transmit an indication for the UE to report predicted beam measurements using a measurement prediction mode from the one or more measurement prediction modes. The communication manager 150 may receive or may cause the reception component 1302 to receive a measurement report associated with the UE indicating one or more predicted beam measurements, the one or more predicted beam measurements being predicted using the measurement prediction mode. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a determination component 1308, among other examples. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive a capability communication, associated with a UE, indicating one or more measurement prediction modes that are supported by the UE, the one or more measurement prediction modes including at least one of a first measurement prediction mode associated with not receiving CSI-RS transmissions for an activation of an unknown TCI state, a second measurement prediction mode associated with receiving CSI-RS transmissions for the activation of the unknown TCI state, or a third measurement prediction mode associated with the unknown TCI state including receive beam information. The transmission component 1304 may transmit an indication for the UE to report predicted beam measurements using a measurement prediction mode from the one or more measurement prediction modes. The reception component 1302 may receive a measurement report associated with the UE indicating one or more predicted beam measurements, the one or more predicted beam measurements being predicted using the measurement prediction mode.

The determination component 1308 may determine signaling or information to be transmitted for the UE when activating the unknown TCI state based at least in part on the measurement prediction mode.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network node, a capability communication indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information; receiving, from the network node, an indication to report predicted beam measurements using a measurement prediction mode from the one or more measurement prediction modes; and transmitting, to the network node, a measurement report indicating one or more predicted beam measurements, the one or more predicted beam measurements being predicted using the measurement prediction mode.

Aspect 2: The method of Aspect 1, wherein the capability communication includes a respective identifier of each of the one or more measurement prediction modes.

Aspect 3: The method of any of Aspects 1-2, wherein the measurement prediction mode is the first measurement prediction mode, the method further comprising: receiving, from the network node, a communication activating the unknown TCI state, the unknown TCI state being associated with a channel measurement resource indicated in the measurement report; and receiving, using a receive beam associated with the channel measurement resource that is associated with the predicted beam measurements, one or more signals associated with the unknown TCI state.

Aspect 4: The method of any of Aspects 1-2, wherein the measurement prediction mode is the second measurement prediction mode, the method further comprising: receiving, from the network node, a communication activating the unknown TCI state, the unknown TCI state being associated with a channel measurement resource indicated in the measurement report, the channel measurement resource being a quasi co-location (QCL) source resource for the unknown TCI state; receiving, from the network node, an indication of a CSI-RS resource set that is associated with repetitions to be associated with the unknown TCI state; receiving, from the network node, one or more CSI-RSs associated with the CSI-RS resource set; and receiving, using a receive beam that is based at least in part on measurements of the one or more CSI-RSs, one or more signals associated with the unknown TCI state.

Aspect 5: The method of any of Aspects 1-2, wherein the measurement prediction mode is the third measurement prediction mode, the method further comprising: receiving, from the network node, a communication activating the unknown TCI state, the unknown TCI state being associated with a channel measurement resource indicated in the measurement report; and receiving, using a receive beam that is based at least in part on the receive beam information, one or more signals associated with the unknown TCI state.

Aspect 6: The method of any of Aspects 1-5, wherein the capability communication is a radio resource control communication that is associated with initial access with the network node.

Aspect 7: The method of any of Aspects 1-6, wherein the one or more measurement prediction modes comprise a first set of one or more measurement prediction modes, the method further comprising: transmitting, to the network node, a communication updating the first set of one or more measurement prediction modes that are supported by the UE to a second set of one or more measurement prediction modes.

Aspect 8: The method of Aspect 7, wherein the measurement prediction mode is not included in the second set of measurement prediction modes, and wherein the measurement prediction mode is supported by the UE until a CSI report configuration associated with the measurement report is deactivated.

Aspect 9: The method of any of Aspects 1-2, 4, and 6-8, wherein the measurement prediction mode is the second measurement prediction mode, the method further comprising: transmitting, to the network node, an indication of a quantity of repetitions to be associated with the CSI-RS transmissions; receiving, from the network node, a communication activating the unknown TCI state, the unknown TCI state being associated with a channel measurement resource indicated in the measurement report; and receiving, from the network node, a configuration or scheduling information for a CSI-RS set that is associated with the quantity of repetitions.

Aspect 10: The method of Aspect 9, wherein the indication of the quantity of repetitions includes an indication of at least one of: a quantity of receive beams, or a quantity of synchronization signal block (SSB) cycles.

Aspect 11: The method of any of Aspects 1-2, 5, and 6-8, wherein the measurement prediction mode is the third measurement prediction mode, the method further comprising: receiving, from the network node, a first communication activating the unknown TCI state, the unknown TCI state being associated with a channel measurement resource indicated in the measurement report, the unknown TCI state including information associated with a set of receive beams; receiving, from the network node, a second communication scheduling a data communication associated with the unknown TCI state, the second communication indicating a receive beam, from the set of receive beams; and receiving, using the receive beam, the data communication.

Aspect 12: A method of wireless communication performed by a network node, comprising: receiving a capability communication, associated with a user equipment (UE), indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information; transmitting an indication for the UE to report predicted beam measurements using a measurement prediction mode from the one or more measurement prediction modes; and receiving a measurement report associated with the UE indicating one or more predicted beam measurements, the one or more predicted beam measurements being predicted using the measurement prediction mode.

Aspect 13: The method of Aspect 12, wherein the capability communication includes a respective identifier of each of the one or more measurement prediction modes.

Aspect 14: The method of any of Aspects 12-13, wherein the measurement prediction mode is the first measurement prediction mode, the method further comprising: transmitting a communication activating the unknown TCI state, the unknown TCI state being associated with a channel measurement resource indicated in the measurement report; and transmitting one or more signals associated with the unknown TCI state.

Aspect 15: The method of any of Aspects 12-13, wherein the measurement prediction mode is the second measurement prediction mode, the method further comprising: transmitting a communication activating the unknown TCI state, the unknown TCI state being associated with a channel measurement resource indicated in the measurement report, the channel measurement resource being a quasi co-location (QCL) source resource for the unknown TCI state; transmitting an indication of a CSI-RS resource set that is associated with repetitions to be associated with the unknown TCI state; and transmitting one or more CSI-RSs associated with the CSI-RS resource set; and transmitting one or more signals associated with the unknown TCI state.

Aspect 16: The method of any of Aspects 12-13, wherein the measurement prediction mode is the third measurement prediction mode, the method further comprising: transmitting a communication activating the unknown TCI state, the unknown TCI state being associated with a channel measurement resource indicated in the measurement report; and transmitting one or more signals associated with the unknown TCI state.

Aspect 17: The method of any of Aspects 12-16, wherein the capability communication is a radio resource control communication that is associated with initial access with the network node.

Aspect 18: The method of any of Aspects 12-17, wherein the one or more measurement prediction modes comprise a first set of one or more measurement prediction modes, the method further comprising: receiving a communication updating the first set of one or more measurement prediction modes that are supported by the UE to a second set of one or more measurement prediction modes.

Aspect 19: The method of Aspect 18, wherein the measurement prediction mode is not included in the second set of measurement prediction modes, and wherein the measurement prediction mode is supported by the UE until a CSI report configuration associated with the measurement report is deactivated.

Aspect 20: The method of any of Aspects 12-13, 15, and 17-19, wherein the measurement prediction mode is the second measurement prediction mode, the method further comprising: receiving an indication of a quantity of repetitions to be associated with the CSI-RS transmissions; and transmitting a communication activating the unknown TCI state, the unknown TCI state being associated with a channel measurement resource indicated in the measurement report; and transmitting a configuration or scheduling information for a CSI-RS set that is associated with the quantity of repetitions.

Aspect 21: The method of Aspect 20, wherein the indication of the quantity of repetitions includes an indication of at least one of: a quantity of receive beams, or a quantity of synchronization signal block (SSB) cycles.

Aspect 22: The method of any of Aspects 12-13, 16, and 17-19, wherein the measurement prediction mode is the third measurement prediction mode, the method further comprising: transmitting a first communication activating the unknown TCI state, the unknown TCI state being associated with a channel measurement resource indicated in the measurement report, the unknown TCI state including information associated with a set of receive beams; transmitting a second communication scheduling a data communication associated with the unknown TCI state, the second communication indicating a receive beam, from the set of receive beams; and transmitting the data communication.

Aspect 23: An apparatus for wireless communication at a device, comprising a processor; memory coupled with the processor; and instructions stored in the memory and executable by the processor to cause the apparatus to perform the method of one or more of Aspects 1-11.

Aspect 24: A device for wireless communication, comprising a memory and one or more processors coupled to the memory, the one or more processors configured to perform the method of one or more of Aspects 1-11.

Aspect 25: An apparatus for wireless communication, comprising at least one means for performing the method of one or more of Aspects 1-11.

Aspect 26: A non-transitory computer-readable medium storing code for wireless communication, the code comprising instructions executable by a processor to perform the method of one or more of Aspects 1-11.

Aspect 27: A non-transitory computer-readable medium storing a set of instructions for wireless communication, the set of instructions comprising one or more instructions that, when executed by one or more processors of a device, cause the device to perform the method of one or more of Aspects 1-11.

Aspect 28: An apparatus for wireless communication at a device, comprising a processor; memory coupled with the processor; and instructions stored in the memory and executable by the processor to cause the apparatus to perform the method of one or more of Aspects 12-22.

Aspect 29: A device for wireless communication, comprising a memory and one or more processors coupled to the memory, the one or more processors configured to perform the method of one or more of Aspects 12-22.

Aspect 30: An apparatus for wireless communication, comprising at least one means for performing the method of one or more of Aspects 12-22.

Aspect 31: A non-transitory computer-readable medium storing code for wireless communication, the code comprising instructions executable by a processor to perform the method of one or more of Aspects 12-22.

Aspect 32: A non-transitory computer-readable medium storing a set of instructions for wireless communication, the set of instructions comprising one or more instructions that, when executed by one or more processors of a device, cause the device to perform the method of one or more of Aspects 12-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor communicatively coupled with the at least one memory, the at least one processor operable to cause the UE to:
transmit, to a network node, a capability communication indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information;
receive, from the network node, an indication to report predicted beam measurements using a measurement prediction mode from the one or more measurement prediction modes; and
transmit, to the network node, a measurement report indicating one or more predicted beam measurements, the one or more predicted beam measurements being predicted using the measurement prediction mode.

2. The UE of claim 1, wherein the capability communication includes a respective identifier of each of the one or more measurement prediction modes.

3. The UE of claim 1, wherein the measurement prediction mode is the first measurement prediction mode, wherein the at least one processor is further operable to cause the UE to:
receive, from the network node, a communication activating the unknown TCI state, the unknown TCI state being associated with a channel measurement resource indicated in the measurement report; and
receive, using a receive beam associated with the channel measurement resource that is associated with the predicted beam measurements, one or more signals associated with the unknown TCI state.

4. The UE of claim 1, wherein the measurement prediction mode is the second measurement prediction mode, wherein the at least one processor is further operable to cause the UE to:
receive, from the network node, a communication activating the unknown TCI state, the unknown TCI state being associated with a channel measurement resource indicated in the measurement report, the channel measurement resource being a quasi co-location (QCL) source resource for the unknown TCI state;
receive, from the network node, an indication of a CSI-RS resource set that is associated with repetitions to be associated with the unknown TCI state;
receive, from the network node, one or more CSI-RSs associated with the CSI-RS resource set; and
receive, using a receive beam that is based at least in part on measurements of the one or more CSI-RSs, one or more signals associated with the unknown TCI state.

5. The UE of claim 1, wherein the measurement prediction mode is the third measurement prediction mode, wherein the at least one processor is further operable to cause the UE to:
receive, from the network node, a communication activating the unknown TCI state, the unknown TCI state being associated with a channel measurement resource indicated in the measurement report; and
receive, using a receive beam that is based at least in part on the receive beam information, one or more signals associated with the unknown TCI state.

6. The UE of claim 1, wherein the capability communication is a radio resource control communication that is associated with initial access with the network node.

7. The UE of claim 1, wherein the one or more measurement prediction modes comprise a first set of one or more measurement prediction modes, wherein the at least one processor is further operable to cause the UE to:
transmit, to the network node, a communication updating the first set of one or more measurement prediction modes that are supported by the UE to a second set of one or more measurement prediction modes.

8. The UE of claim 7, wherein the measurement prediction mode is not included in the second set of measurement prediction modes, and wherein the measurement prediction mode is supported by the UE until a CSI report configuration associated with the measurement report is deactivated.

9. The UE of claim 1, wherein the measurement prediction mode is the second measurement prediction mode, wherein the at least one processor is further operable to cause the UE to:
transmit, to the network node, an indication of a quantity of repetitions to be associated with the CSI-RS transmissions; and
receive, from the network node, a communication activating the unknown TCI state, the unknown TCI state being associated with a channel measurement resource indicated in the measurement report; and
receive, from the network node, a configuration or scheduling information for a CSI-RS set that is associated with the quantity of repetitions.

10. The UE of claim 9, wherein the indication of the quantity of repetitions includes an indication of at least one of:
a quantity of receive beams, or
a quantity of synchronization signal block (SSB) cycles.

11. The UE of claim 1, wherein the measurement prediction mode is the third measurement prediction mode, wherein the at least one processor is further operable to cause the UE to:
receive, from the network node, a first communication activating the unknown TCI state, the unknown TCI state being associated with a channel measurement resource indicated in the measurement report, the unknown TCI state including information associated with a set of receive beams;
receive, from the network node, a second communication scheduling a data communication associated with the unknown TCI state, the second communication indicating a receive beam, from the set of receive beams; and
receive, using the receive beam, the data communication.

12. A network node for wireless communication, comprising:
at least one memory; and
at least one processor communicatively coupled with the at least one memory, the at least one processor operable to cause the network node to:
receive a capability communication, associated with a user equipment (UE), indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information;
transmit an indication for the UE to report predicted beam measurements using a measurement prediction mode from the one or more measurement prediction modes; and
receive a measurement report associated with the UE indicating one or more predicted beam measurements, the one or more predicted beam measurements being predicted using the measurement prediction mode.

13. The network node of claim 12, wherein the measurement prediction mode is the second measurement prediction mode, wherein the at least one processor is further operable to cause the network node to:
transmit a communication activating the unknown TCI state, the unknown TCI state being associated with a channel measurement resource indicated in the measurement report, the channel measurement resource being a quasi co-location (QCL) source resource for the unknown TCI state;
transmit an indication of a CSI-RS resource set that is associated with repetitions to be associated with the unknown TCI state;
transmit one or more CSI-RSs associated with the CSI-RS resource set; and
transmit one or more signals associated with the unknown TCI state.

14. The network node of claim 12, wherein the measurement prediction mode is the third measurement prediction mode, wherein the at least one processor is further operable to cause the network node to:
transmit a communication activating the unknown TCI state, the unknown TCI state being associated with a channel measurement resource indicated in the measurement report, the unknown TCI state including the receive beam information ; and
transmit one or more signals associated with the unknown TCI state.

15. The network node of claim 12, wherein the one or more measurement prediction modes comprise a first set of one or more measurement prediction modes, wherein the at least one processor is further operable to cause the network node to:
receive a communication updating the first set of one or more measurement prediction modes that are supported by the UE to a second set of one or more measurement prediction modes.

16. A method of wireless communication performed by a user equipment (UE), comprising:
transmitting, to a network node, a capability communication indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information;
receiving, from the network node, an indication to report predicted beam measurements using a measurement prediction mode from the one or more measurement prediction modes; and
transmitting, to the network node, a measurement report indicating one or more predicted beam measurements, the one or more predicted beam measurements being predicted using the measurement prediction mode.

17. (canceled)

18. The method of claim 16, wherein the measurement prediction mode is the first measurement prediction mode, the method further comprising:
receiving, from the network node, a communication activating the unknown TCI state, the unknown TCI state being associated with a channel measurement resource indicated in the measurement report; and
receiving, using a receive beam associated with the channel measurement resource that is associated with the predicted beam measurements, one or more signals associated with the unknown TCI state.

19. The method of claim 16, wherein the measurement prediction mode is the second measurement prediction mode, the method further comprising:
receiving, from the network node, a communication activating the unknown TCI state, the unknown TCI state being associated with a channel measurement resource indicated in the measurement report, the channel measurement resource being a quasi co-location (QCL) source resource for the unknown TCI state;
receiving, from the network node, an indication of a CSI-RS resource set that is associated with repetitions to be associated with the unknown TCI state;
receiving, from the network node, one or more CSI-RSs associated with the CSI-RS resource set; and
receiving, using a receive beam that is based at least in part on measurements of the one or more CSI-RSs, one or more signals associated with the unknown TCI state.

20. The method of claim 16, wherein the measurement prediction mode is the third measurement prediction mode, the method further comprising:
receiving, from the network node, a communication activating the unknown TCI state, the unknown TCI state being associated with a channel measurement resource indicated in the measurement report; and
receiving, using a receive beam that is based at least in part on the receive beam information, one or more signals associated with the unknown TCI state.

21-26. (canceled)

27. A method of wireless communication performed by a network node, comprising:
receiving a capability communication, associated with a user equipment (UE), indicating one or more measurement prediction modes that are supported by the UE, the one or more measurement prediction modes including at least one of a first measurement prediction mode associated with not receiving channel state information (CSI) reference signal (CSI-RS) transmissions for an activation of an unknown transmission configuration indicator (TCI) state, a second measurement prediction mode associated with receiving CSI-RS transmissions for the activation of the unknown TCI state, or a third measurement prediction mode associated with the unknown TCI state including receive beam information;
transmitting an indication for the UE to report predicted beam measurements using a measurement prediction mode from the one or more measurement prediction modes; and
receiving a measurement report associated with the UE indicating one or more predicted beam measurements, the one or more predicted beam measurements being predicted using the measurement prediction mode.

28-30. (canceled)
